(19) United States
(12) Patent Application Publication
(10) Pub. No.: US 2024/0283176 A1
(43) Pub. Date: Aug. 22, 2024

(54) LOW PROFILE BOARD-TO-BOARD INTERFACE CONTACTORS

(71) Applicant: Molex, LLC, Lisle, IL (US)

(72) Inventors: Gino Stephen Antonini, New Fairfield, CT (US); Daniel Ardell White, Plainfield, IN (US); William E. Spink, JR., Zionsville, IN (US); James William Borrelli, JR., Watertown, CT (US); Bharath Dattatri Bharadwaj, Bengaluru (IN); Jean-Louis Mendes, Staffanstorp (SE); Kevin J. Tagan, Torrington, CT (US)

(21) Appl. No.: 18/438,530

(22) Filed: Feb. 12, 2024

Related U.S. Application Data
(60) Provisional application No. 63/455,424, filed on Mar. 29, 2023.
(60) Provisional application No. 63/446,194, filed on Feb. 16, 2023.

(51) Int. Cl. H01R 12/71; H01R 12/91; H01R 13/24; H01R 13/434; H01R 13/6587; H01R 103/00

(52) U.S. Cl. CPC H01R 12/714; H01R 12/91; H01R 13/2421; H01R 13/2428; H01R 13/2471; H01R 13/434; H01R 13/6587; H01R 2103/00

(57) ABSTRACT

Low profile board-to-board interface contactors are described. In one example, a board-to-board interface contactor includes a contactor base body having a peripheral seat and an aperture, an elastic and conductive lid positioned over the peripheral seat of the contactor base body, and a conductive pin extending through the aperture in the contactor base body. The contactor base body can include one or more mounting legs, and outer surfaces of the peripheral seat and the mounting leg can be plated with one or more metals and be conductive. The elastic and conductive lid can be embodied as a conductive foam material. The interface contactor can provide a first conductive pathway between the elastic and conductive lid, the peripheral seat, and the mounting leg, and a second conductive pathway through the conductive pin.

### RELATED APPLICATIONS

This application claims priority to and the benefit of U.S. Provisional Patent Application No. 63/446,194 filed on Feb. 16, 2023 and U.S. Provisional Patent Application No. 63/455,424 filed on Mar. 29, 2023. The entireties of the disclosures of the provisional patent applications are incorporated herein by reference.

### BACKGROUND

Connectors, connector assemblies, and housings for connectors are important structural and functional components in many computing and data interconnect systems. A number of different types and styles of connectors are known and used to electrically transfer data and radio frequency signals among interconnected boards and systems. Board-to-board connectors are relied upon to electrically couple data signals, radio frequency signals, and power between various types of printed circuit boards and other electrical and electro-mechanical assemblies. With the continued increase in the number of features and capabilities of electronics and related devices, such as cellular phones, computers, tablets, and other devices, many devices now include several printed circuits boards and related assemblies in a common housing.

### SUMMARY

A number of low profile board-to-board interface contactors are described. In one example, a board-to-board interface contactor includes a contactor base body having a peripheral seat and an aperture, an elastic and conductive lid positioned over the peripheral seat of the contactor base body, and a conductive pin extending through the aperture in the contactor base body. The contactor base body can include one or more mounting legs, and outer surfaces of the peripheral seat and the mounting leg can be plated with one or more metals and be conductive. The elastic and conductive lid can be embodied as a conductive foam material. The interface contactor can provide a first conductive pathway between the elastic and conductive lid, the peripheral seat, and the mounting leg, and a second conductive pathway through the conductive pin.

In another example, a board-to-board interface contactor includes a contactor base housing with a housing seat flange, an elastic and conductive lid positioned over the housing seat flange of the contactor base housing, an insulating interposer positioned within the contactor base housing, and a conductive pin extending through an aperture in the insulating interposer. The clastic and conductive lid can be embodied as a conductive foam material, and the interface contactor includes a conductive pathway between the elastic and conductive lid and the contactor base housing. The interface contactor includes a second conductive pathway through the conductive pin. The conductive pathway between the elastic and conductive lid and the contactor base housing is electrically insulated from the second conductive pathway through the conductive pin.

In another example, a board-to-board interface contactor includes a contactor base housing with a spring seat flange, a spring positioned over the spring seat flange of the contactor base housing, a contactor shield extending in part between the spring and the contactor base housing, an insulating interposer positioned within the contactor base housing, and a conductive pin extending through an aperture in the insulating interposer. The contactor shield includes an upper rim, a lower barrel, and a central opening extending within the lower barrel. The spring provides a spring bias between the spring seat flange of the contactor base housing and the upper rim of the contactor shield.

In another example, a board-to-board interface contactor includes a shield body housing, an insulating interposer positioned within the shield body housing, a wave spring positioned over the insulating interposer, a shield lid positioned over the shield body housing and the wave spring, and a conductive pin extending through an aperture in the insulating interposer. The insulating interposer includes an interlock extension that extends beyond an outer cylindrical surface of the insulating interposer, the shield body housing includes an interlock aperture, and the interlock extension of the insulating interposer is positioned within the interlock aperture of the shield body housing, to maintain the position of the insulating interposer within the shield body housing. In other aspects, the shield lid includes an interlock arm, the shield body housing includes an extension channel, and the interlock arm of the shield lid is positioned within the extension channel of the shield body housing.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an example board-to-board interface contactor according to various embodiments of the present disclosure.

FIG. 1B illustrates a side view of the interface contactor shown in FIG. 1A according to various embodiments of the present disclosure.

FIG. 1C illustrates a top-down view of the interface contactor shown in FIG. 1A according to various embodiments of the present disclosure.

FIG. 1D illustrates a bottom-up view of the interface contactor shown in FIG. 1A according to various embodiments of the present disclosure.

FIG. 1E illustrates a perspective view of the contactor base body of the interface contactor shown in FIG. 1A according to various embodiments of the present disclosure.

FIG. 1F illustrates a perspective view of the pin of the interface contactor shown in FIG. 1A according to various embodiments of the present disclosure.

FIG. 1G illustrates the cross-sectional view of the interface contactor designated A-A in FIG. 1A according to various embodiments of the present disclosure.

FIG. 1H illustrates an example of the interface contactor shown in FIG. 1A between two printed circuit boards according to various embodiments of the present disclosure.

FIG. 1I illustrates an example of the interface contactor shown in FIG. 1A in a compressed state according to various embodiments of the present disclosure.

FIG. 2A illustrates a perspective view of another example board-to-board interface contactor according to various embodiments of the present disclosure.

FIG. 2B illustrates a side view of the interface contactor shown in FIG. 2A according to various embodiments of the present disclosure.

FIG. 2C illustrates a top-down view of the interface contactor shown in FIG. 2A according to various embodiments of the present disclosure.

FIG. 2D illustrates a bottom-up view of the interface contactor shown in FIG. 2A according to various embodiments of the present disclosure.

FIG. 2E illustrates a perspective view of a contactor base housing, an insulating interposer, and a conductive pin of the interface contactor shown in FIG. 2A according to various embodiments of the present disclosure.

FIG. 2F illustrates a perspective view of the contactor base housing of the interface contactor shown in FIG. 2A according to various embodiments of the present disclosure.

FIG. 2G illustrates a perspective view of the insulating interposer and the conductive pin of the interface contactor shown in FIG. 2A according to various embodiments of the present disclosure.

FIG. 2H illustrates an example of the interface contactor shown in FIG. 2A in a compressed state according to various embodiments of the present disclosure.

FIG. 3A illustrates a perspective view of another example board-to-board interface contactor according to various embodiments of the present disclosure.

FIG. 3B illustrates a side view of the interface contactor shown in FIG. 3A according to various embodiments of the present disclosure.

FIG. 3C illustrates a top-down view of the interface contactor shown in FIG. 3A according to various embodiments of the present disclosure.

FIG. 3D illustrates a bottom-up view of the interface contactor shown in FIG. 3A according to various embodiments of the present disclosure.

FIG. 3E illustrates a perspective view of a contactor base housing, a contactor shield, and a conductive pin of the interface contactor shown in FIG. 3A according to various embodiments of the present disclosure.

FIG. 3F illustrates a perspective view of the contactor shield of the interface contactor shown in FIG. 3A according to various embodiments of the present disclosure.

FIG. 3G illustrates a perspective view of the contactor base housing, the insulating interposer, and the conductive pin of the interface contactor shown in FIG. 3A according to various embodiments of the present disclosure.

FIG. 3H illustrates an example of the contactor base housing of the interface contactor shown in FIG. 3A according to various embodiments of the present disclosure.

FIG. 3I illustrates an example of the insulating interposer and conductive pin of the interface contactor shown in FIG. 3A according to various embodiments of the present disclosure.

FIG. 3J illustrates an example of the interface contactor shown in FIG. 3A in a compressed state according to various embodiments of the present disclosure.

FIG. 4A illustrates a perspective view of another example board-to-board interface contactor according to various embodiments of the present disclosure.

FIG. 4B illustrates a top-down view of the interface contactor shown in FIG. 4A according to various embodiments of the present disclosure.

FIG. 4C illustrates a bottom-up view of the interface contactor shown in FIG. 4A according to various embodiments of the present disclosure.

FIG. 4D illustrates a perspective view of a shield lid of the interface contactor shown in FIG. 4A according to various embodiments of the present disclosure.

FIG. 4E illustrates a perspective view of a shield body housing of the interface contactor shown in FIG. 4A according to various embodiments of the present disclosure.

FIG. 4F illustrates a perspective view of an insulating interposer and a conductive pin of the interface contactor shown in FIG. 4A according to various embodiments of the present disclosure.

FIG. 4G illustrates a perspective view of a spring, a shield body housing, an insulating interposer, and a conductive pin of the interface contactor shown in FIG. 4A according to various embodiments of the present disclosure.

FIG. 4H illustrates an example of the interface contactor shown in FIG. 4A in a compressed state according to various embodiments of the present disclosure.

### DETAILED DESCRIPTION

Connectors, connector assemblies, and housings for connectors are important structural and functional components in many computing and data interconnect systems. A number of different types and styles of connectors are known and used to electrically transfer data and radio frequency (RF) signals among interconnected systems. Board-to-board connectors are relied upon to electrically couple data signals, RF signals, and power between various types of printed circuit boards (PCBs) and other electrical and electro-mechanical assemblies. With the continued miniaturization of electronics and related devices, such as cellular phones, computers, tablets, and other devices, engineers are working to package many different PCBs closely together in a common housing. One limitation for arranging PCBs into closer proximity with each other, however, is the size of the board-to-board and other connectors and contactors used to electrically communicate the data and RF signals among them.

In the context outlined above, a number of low profile board-to-board interface contactors are described. In one example, a board-to-board interface contactor includes a contactor base body having a peripheral seat and an aperture, an elastic and conductive lid positioned over the peripheral seat of the contactor base body, and a conductive pin extending through the aperture in the contactor base body. The contactor base body can include one or more mounting legs, and outer surfaces of the peripheral seat and the mounting leg can be plated with one or more metals and be conductive. The clastic and conductive lid can be embodied as a conductive foam material. The interface contactor can provide a first conductive pathway between the clastic and conductive lid, the peripheral seat, and the mounting leg, and a second conductive pathway through the conductive pin. Another board-to-board interface contactor includes a contactor base housing with a housing seat flange, an elastic and conductive lid positioned over the housing seat flange of the contactor base housing, an insulating interposer positioned within the contactor base housing, and a conductive pin extending through an aperture in the insulating interposer. The clastic and conductive lid can be embodied as a conductive foam material, and the interface contactor includes a conductive pathway between the elastic and conductive lid and the contactor base housing. The interface contactor includes a second conductive pathway through the conductive pin. The conductive pathway between the clastic and conductive lid and the contactor base housing is electrically insulated from the second conductive pathway through the conductive pin.

Another board-to-board interface contactor includes a contactor base housing with a spring seat flange, a spring positioned over the spring seat flange of the contactor base housing, a contactor shield extending in part between the spring and the contactor base housing, an insulating interposer positioned within the contactor base housing, and a conductive pin extending through an aperture in the insulating interposer. The contactor shield includes an upper rim, a lower barrel, and a central opening extending within the lower barrel. The spring provides a spring bias between the spring seat flange of the contactor base housing and the upper rim of the contactor shield.

Another board-to-board interface contactor includes a shield body housing, an insulating interposer positioned within the shield body housing, a wave spring positioned over the insulating interposer, a shield lid positioned over the shield body housing and the wave spring, and a conductive pin extending through an aperture in the insulating interposer. The insulating interposer includes an interlock extension that extends beyond an outer cylindrical surface of the insulating interposer, the shield body housing includes an interlock aperture, and the interlock extension of the insulating interposer is positioned within the interlock aperture of the shield body housing, to maintain the position of the insulating interposer within the shield body housing. In other aspects, the shield lid includes an interlock arm, the shield body housing includes an extension channel, and the interlock arm of the shield lid is positioned within the extension channel of the shield body housing.

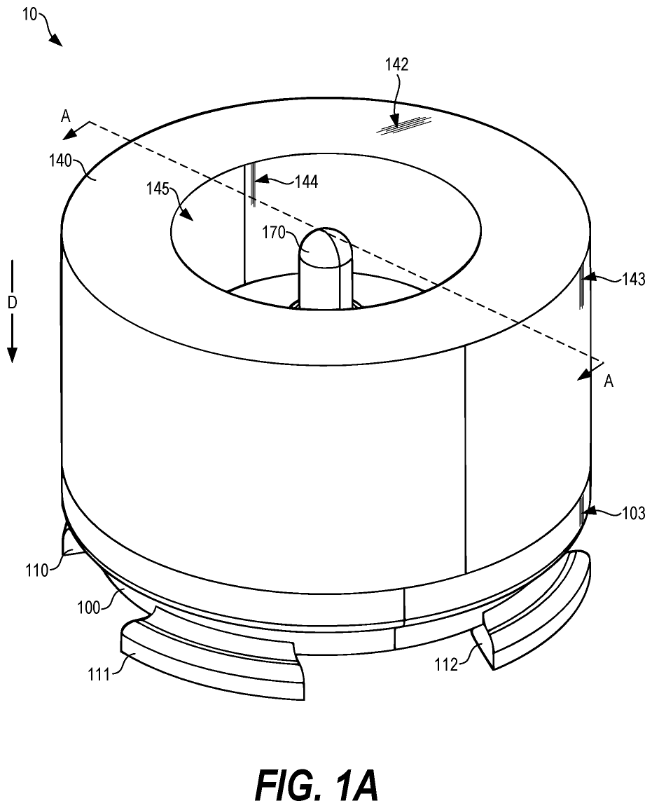

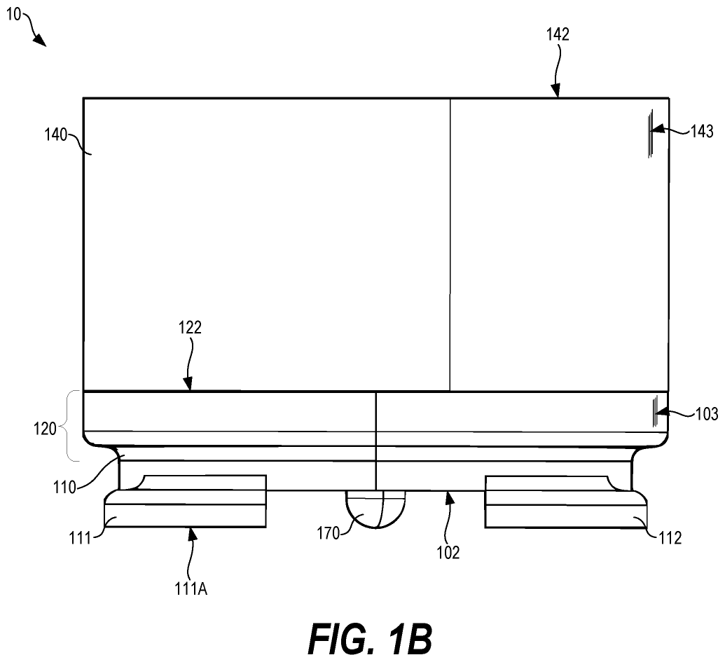

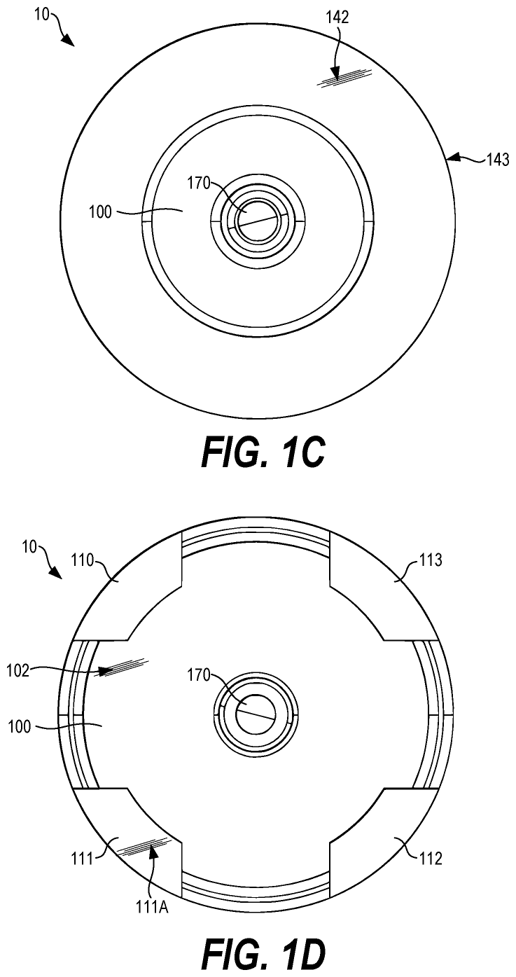

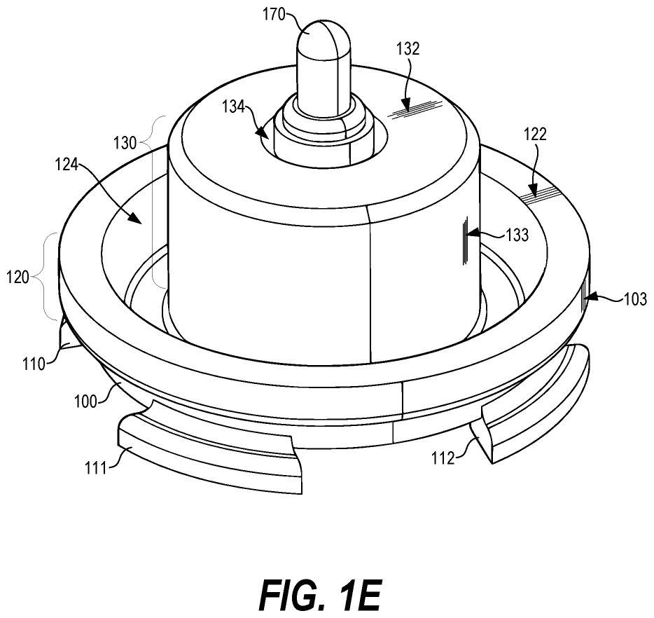

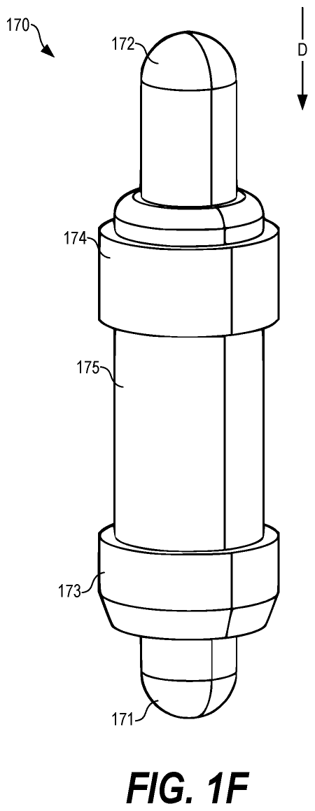

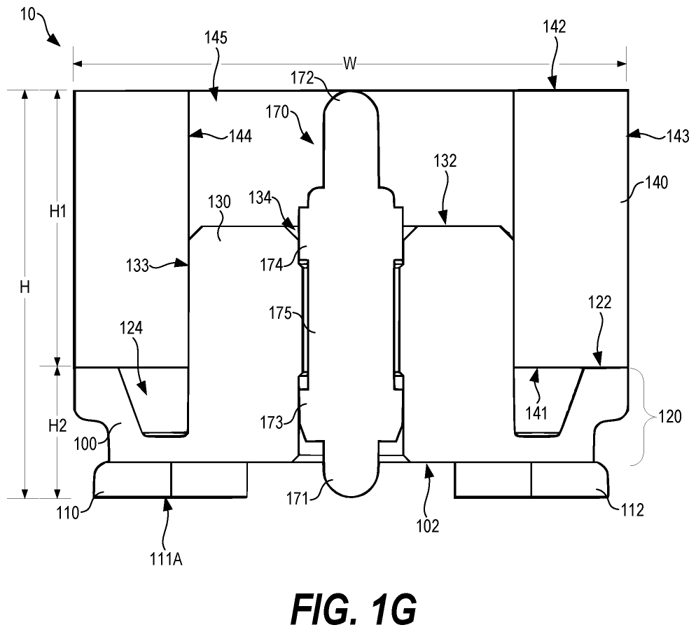

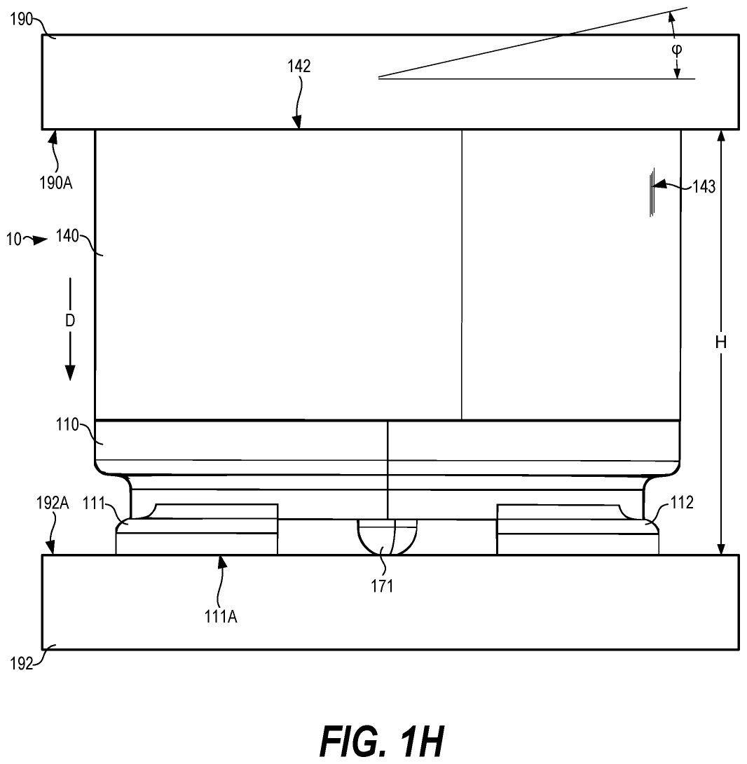

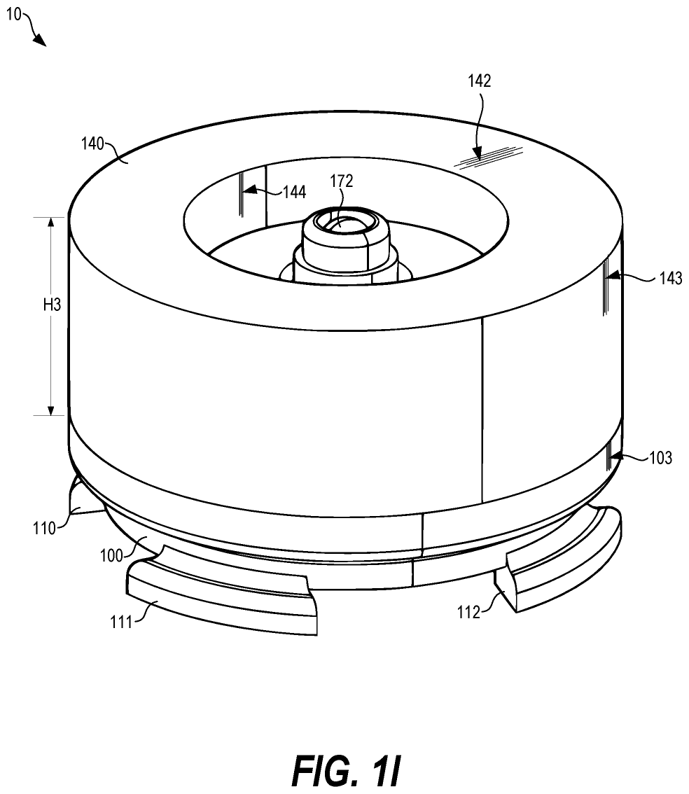

Turning to the drawings, FIG. 1A illustrates a perspective view of an example board-to-board interface contactor 10 (“interface contactor 10”) according to various embodiments of the present disclosure. Additionally, FIG. 1B illustrates a side view, FIG. 1C illustrates a top-down view, and FIG. 1D illustrates a bottom-up view of the interface contactor 10 shown in FIG. 1A. The interface contactor 10 can be relied upon as a type of low profile board-to-board interface contactor for electrically coupling an RF signal, for example, between two different PCBs, as described herein. The interface contactor 10 is representative, not drawn to any particular scale, and is illustrated to provide context for the concepts of the low profile board-to-board interface contactors or connectors described herein. The interface contactors described herein can be formed in a range of different sizes, shapes, and styles, although certain sizes and shapes are described and illustrated. Other types or styles of interface contactors are also described in further detail below. The interface contactors described herein can be used in a range of interconnect applications, although board-to-board interface applications are described in some examples.

Referring among FIGS. 1A-1D, the interface contactor 10 includes a contactor base body 100 (also “base body 100”), an elastic and conductive lid 140 (also “lid 140”) over the base body 100, and a conductive pin 170 (also “pin 170”). FIG. 1E illustrates a perspective view of the base body 100 and the pin 170, with the lid 140 omitted from view. FIG. 1F illustrates a perspective view of the pin 170, with the base body 100 and the lid 140 omitted from view. When electrically coupled as a connector or contactor between PCBs, the lid 140 and the base body 100 can be electrically coupled to conductive ground, common, or drain contact pads on the PCBs, and the pin 170 can be electrically coupled to RF or other conductive signal traces or contact pads on the PCBs. The interface contactor 10 can be compressed to some extent in the direction “D” when electrically coupled between PCBs, as also described below with reference to FIG. 1H.

The base body 100 can be formed from an insulating material, such as liquid crystal polymer (LCP), polyethylene (PE), polytetrafluoroethylene (PTFE), or other plastic or insulating materials using any suitable additive or subtractive manufacturing techniques, including molding, injection molding, printing, and other techniques. Certain surfaces of the base body 100 can be plated with a plating metal or metals (e.g., plated for conductivity) as described below. The surfaces can be metalized or plated in a bath, plated by electroless plating, electroplating, sputter plating, ion plating, or other plating techniques or a combination thereof. The surfaces can be metalized or plated with copper, nickel, tin, gold, or another plating metal or combination of plating metals.

The insulating material from which the base body 100 is formed can include a laser direct structuring (LDS) additive in some cases. A laser beam can be used to activate the LDS additive over certain surfaces or surface areas of the base body 100 for metallization. A subsequent metallization step can be performed by submerging the base body 100 in a bath, and conductive metal plating can adhere to the activated surfaces or surface areas of the base body 100. A number of different layers of metal, such as copper, nickel, tin, gold, or other plating metals or combinations thereof can be successively plated using this approach. Thus, certain surfaces of base body 100 are conductive and act as a conductive ground, common, or drain path on the interface contactor 10. The conductive surfaces of the base body 100 are identified and described below. However, the plated surfaces of the base body 100 do not extend to or make contact with the pin 170 or the surfaces of the base body 100 that contact the pin 170. Thus, the insulating material of the base body 100 electrically isolates the pin 170 from the plated surfaces of the base body 100. The insulating material of the base body 100 provides a dielectric insulator between the pin 170 and the plated surfaces of the base body 100.

The base body 100 is generally circular when viewed from the top or the bottom, as best shown in FIGS. 1C and 1D. The base body 100 includes a number of legs 110-113 for mounting the interface contactor 10 at the lower end of the base body 100. The base body 100 includes four legs 110-113 in the example shown, and the legs 110-113 are equally spaced apart around the periphery of the lower end of the base body 100. The base body 100 can include a different number of legs in other cases. For example, the base body 100 can include one, two, three, four, five, six, or more legs in other cases. The legs 110-113 are designed for a surface mount coupling to a PCB. However, the base body 100 can include other types or styles of legs for mounting. For example, the base body 100 can include through-hole posts for insertion through apertures of a PCB, such as plated apertures or vias in some cases.

The surfaces of the legs 110-113 can be plated for conductivity, and the bottom surfaces of the legs 110-113 shown in FIG. 1D can be mounted and electrically coupled (e.g., soldered, sintered, etc.) to conductive traces or pads of a PCB. A bottom surface 111A of the leg 111 is identified in FIG. 1D, and each of the legs 110, 112, and 113 includes a similar bottom surface, all extending in the same plane. A lower surface 102 of the base body 100 is also identified in FIG. 1D. The lower surface 102 extends in a plane that is parallel to the plane in which the bottom surface 111A of the leg 111 and the bottom surfaces of the legs 110, 112, and 113 extend, as also shown in FIG. 1B.

Referring to FIG. 1E, the base body 100 also includes a peripheral seat 120 and a body pedestal 130. The peripheral seat 120 extends around the body pedestal 130 and includes an upper seat surface 122. The upper seat surface 122 extends in a plane that is parallel to the plane in which the bottom surfaces of the legs 110-113 extend (see also FIG. 1B). The upper seat surface 122 is separated from an outer cylindrical surface 133 of the body pedestal 130 by a groove 124 that extends circularly between them. In other cases, the groove 124 can be omitted and the upper seat surface 122 can extend to the outer cylindrical surface 133 of the body pedestal 130. The body pedestal 130 also includes a top surface 132.

A central aperture 134 extends through the base body 100 and particularly through the body pedestal 130. The central aperture 134 extends from a first opening in the top surface 132 of the body pedestal 130, through the body pedestal 130, and to a second opening in the lower surface 102 of the base body 100. The pin 170 is positioned, extends within, and occupies the central aperture 134. As shown in FIGS. 1B and 1E, opposite ends of the pin 170 are exposed both at a top of the base body 100 and at bottom of the base body 100. The pin 170 is also described in further detail below with reference to FIG. 1F.

Certain outer surfaces of the base body 100 are plated with one or more layers of metal and are conductive. Particularly, the outer cylindrical surface 133 of the body pedestal 130 is plated, the outer surfaces of the base body 100 in the groove 124 are plated, the outer surfaces of the peripheral seat 120 are plated, and the outer surfaces of the legs 110-113 are plated in one example. The top surface 132 of the body pedestal 130 is not plated, and the lower surface 102 of the base body 100 is also not plated. The surfaces within the central aperture 134 that extends through the body pedestal 130 are also not plated, and the pin 170 is isolated from the plated surfaces of the base body 100 by the dielectric insulator material from which the base body 100 is formed.

Referring back to FIG. 1A, the lid 140 can be embodied as a conductive foam material. The conductive foam material is clastic and compressible to some extent. As one example, the lid 140 can be embodied as a polyurethane foam multi-laminate including conductive materials, such as copper, nickel, or other conductive metals or materials. As another example, the lid 140 can be embodied as an acrylic adhesive multi-laminate including conductive materials, such as copper, nickel, or other conductive metals or materials. The lid 140 can be embodied as the P-SHIELD® brand PS-1356 or PS-1323 conductive foam manufactured by Polymer Science, Inc. of Monticello, Indiana, as one example, although other suitable types of conductive foams can be relied upon. The lid 140 can be compressible from a pre-load height to a full-travel height over a range, such as compressible between 0.5-1.5 mm, for example, based on an applied force, such as a force between 0.5 to 10 Newtons (N) of force.

The conductive foam material can be cut or otherwise formed into the cylindrical shape of the lid 140 shown in FIG. 1A. The lid 140 includes a central opening 145 that is cut or otherwise formed within the lid 140. The lid 140 includes a bottom surface 141 (see FIG. 1G), a top surface 142, an outer cylindrical surface 143, and an inner cylindrical surface 144. When the interface contactor 10 is assembled as shown in FIG. 1A, the bottom surface 141 of the lid 140 is positioned over and rests upon the upper seat surface 122 (see FIG. 1E) of the peripheral seat 120. The inner cylindrical surface 144 of the lid 140 also contacts a portion of the outer cylindrical surface 133 of the body pedestal 130 in this arrangement. Thus, based on contact between them, the lid 140 is electrically coupled to the plated and conductive surfaces of the base body 100. In some cases, the lid 140 can also be secured to the upper seat surface 122 and the outer cylindrical surface 133 using a conductive adhesive, such as conductive epoxy.

FIG. 1F illustrates a perspective view of the pin 170 of the interface contactor 10 shown in FIG. 1A. The pin 170 is formed from conductive materials, such as copper, brass, nickel, or other metals and is conductive. The pin 170 includes a bottom plunger pin 171, a top plunger pin 172, a lower barrel rim 173, an upper barrel rim 174, and a pin barrel 175. The pin 170 can be spring-loaded and, although not visible in FIG. IF, can include a spring or other biasing member that extends within the pin barrel 175 and between the bottom pin plunger pin 171 and the top plunger pin 172. The spring applies a force to push the bottom plunger pin 171, the top plunger pin 172, or both the bottom and top plunger pins 171 and 172 into the positions shown in FIG. 1F, without any external forces applied against them. However, based on an external force presented upon the top plunger pin 172 in the direction “D,” the top plunger pin 172 can be pushed down into the pin barrel 175, overcoming the spring bias. In some cases, based on an external force presented upon the bottom plunger pin 171 opposite to the direction “D,” the bottom plunger pin 171 can be pushed up into the pin barrel 175, overcoming the spring bias. In one example, the pin 170 can be embodied as a pogo-style pin, but other types and styles of pins can be relied upon.

FIG. 1G illustrates the cross-sectional view of the interface contactor 10 designated A-A in FIG. 1A. As shown, the bottom surface 141 of the lid 140 is positioned over and rests upon the upper seat surface 122 of the peripheral seat 120 of the base body 100. The inner cylindrical surface 144 of the lid 140 also contacts a portion of the outer cylindrical surface 133 of the body pedestal 130. Thus, based on contact between them, the lid 140 is electrically coupled to plated and conductive surfaces of the base body 100. Additionally, the pin 170 is positioned and extends within the central aperture 134. Particularly, the pin 170 is positioned and extends through the body pedestal 130 of the base body 100. The lower barrel rim 173 and the upper barrel rim 174 are seated against inner surfaces or ledges within the central aperture 134, securing the pin 170 in place within the central aperture 134.

Because the top surface 132 and the lower surface 102 of the base body 100 are not plated (and are not conductive), neither the lid 140, which is conductive, nor the plated surfaces of the base body 100 are electrically coupled with the pin 170. Instead, the pin 170 is electrically isolated from the lid 140 and the plated surfaces of the base body 100. Thus, the interface contactor 10 provides two separate conductive pathways for electrical interface purposes. The interface contactor 10 provides a first conductive ground, common, or drain pathway between the top surface 142 of the lid 140 and the bottom surfaces of the legs 110-113 of the base body 100. The interface contactor 10 also provides a second conductive pathway, such as for RF signals, through the pin 170.

The overall height “H” of the interface contactor 10 can range in various embodiments. An example range for “H” can be between 2.5 mm to 7.5 mm, although the interface contactor 10 can be designed to facilitate other spacings between PCBs. As examples, the interface contactor 10 can be designed or sized to facilitate spacings (e.g., dimensions “H”) of 2.5 mm, 3.0 mm, 3.5 mm, 4.0 mm, 5.0 mm, 6.0 mm, 6.5 mm, 7.0 mm, or 7.5 mm, although the interface contactor 10 is not limited to one or more of those sizes. It should be appreciated, in any case, that the interface contactor 10 can accommodate a range of dimensions “H,” as the interface contactor 10 can be compressed over a range of “H.” The width “W” (e.g., the circumference) of the interface contactor 10 can also range in various embodiments. An example range for “W” can be between 4 mm to 15 mm, although the interface contactor 10 is not limited to any width.

The height “H1” of the lid 140, measured between the bottom surface 141 and the top surface 142 of the lid 140, can also range in various embodiments. An example range for “H1” can be between 2 mm to 6 mm, although the lid 140 can be designed to other dimensions. The lid 140 is compressible as noted above. Thus, the height “H1” can vary between about 0.5-1.5 mm, for example, from a pre-load height (i.e., without an externally-applied force) to a full-travel height (i.e., with an externally-applied force) based on a compression force applied between the bottom surface 141 and the top surface 142 of the lid 140. Additionally, the distance “H2,” as measured between the bottom surface 111A of the leg 111 and the upper seat surface 122 of the peripheral seat 120 can range. An example range for “H2” can be between 2 mm to 4 mm, although other dimensions can be relied upon. Other dimensions of the interface contactor 10 can also vary as compared to that shown and described.

FIG. 1H illustrates an example of the interface contactor 10 shown in FIG. 1A between two PCBs 190 and 192 according to various embodiments of the present disclosure. The PCBs 190 and 192 can be arranged together in a housing of a device and secured separately therein, with the interface contactor 10 positioned between them. The illustration in FIG. 1H is representative and provided to convey the concepts of the low profile board-to-board interface contactors or connectors described herein. Although only one interface contactor is shown in FIG. 1H, any number of interface contactors can be positioned between the PCBs 190 and 192 or other PCBs according to the embodiments, so that any number of different signals can be coupled between them.

The interface contactor 10, among possibly others, can be relied upon to electrically couple signals between the PCBs 190 and 192. To that end, the interface contactor 10 can be positioned between the outer planar surfaces of the PCBs 190 and 192 to form electrical couplings between conductive pads or traces that are exposed on them. In one example, bottom surfaces of the legs 110-113 can be contacted and electrically coupled to one or more conductive traces or pads on an upper surface 192A on the PCB 192, to form a common or drain coupling between the PCB 192 and the interface contactor 10. That is, the bottom surface 111A of the leg 111 and the bottom surfaces of the other legs 110, 112, and 113 can be contacted and electrically coupled to one or more conductive traces or pads on an upper surface 192A on the PCB 192. In some cases, the bottom surfaces of the legs 110-113 can be soldered, sintered, or otherwise electrically coupled to conductive traces or pads on an upper surface 192A on the PCB 192 for a common or ground connection. Additionally, the bottom plunger pin 171 of the pin 170 can also be electrically coupled (e.g., via contact, soldered, sintered, etc.) to another conductive trace or pad on the upper surface 192A of the PCB 192 for an electrical signal coupling between the PCB 192 and the pin 170.

The PCB 190 can be brought into position and contact with the top surface 142 of the lid 140, so that the lower surface 190A of the PCB 190 contacts the top surface 142. One or more conductive traces or pads of the PCB 190 can make electrical contact with the top surface 142 of the lid 140 for a common or ground connection. Another conductive trace or pad of the PCB 190 can make electrical contact with the top plunger pin 172 of the pin 170 for an electrical signal coupling. Based on the arrangement of the PCBs 190 and 192 (i.e., how closely they are mounted with respect to each other), the PCB 190 can also apply a downward pressure or force upon the top surface 142 of the lid 140 in the direction “D,” pushing the lid 140 down in the direction “D.” As noted above, the lid 140 is elastic and compressible to some extent, and the lid 140 can be compressed between the PCBs 190 and 192. The PCB 190 can also apply a downward pressure or force upon the top plunger pin 172 of the pin 170 in the direction “D,” pushing top plunger pin 172 down in the direction “D.”

The interface contactor 10 facilitates electrical connections between the PCBs 190 and 192, even if the PCBs 190 and 192 are not arranged to be parallel to each other. For example, the lid 140 of the interface contactor 10 can pivot or tilt to some extent if the surfaces 190A and 192A of the PCBs 190 and 192 do not extend parallel to each other. The angle φ in FIG. 1H is representative of an angle between the lower surface 190A of the PCB 190 and the upper surface 192A of the PCB 192, both of which are assumed to be planar. The interface contactor 10 can accommodate non-zero angles φ. For example, if the angle φ is one, two, or more degrees, the lid 140 of the interface contactor 10 can be compressed in a way to accommodate the angle φ. In various designs, the interface contactor 10 can accommodate angles φ of one, two, three, four, five, six, seven or more degrees, although larger angles can be accommodated in some cases.

In the arrangement shown in FIG. 1H, the height “H” of the interface contactor 10 is shown between the lower surface 190A of the PCB 190 and the upper surface 192A of the PCB 192, although this dimension can vary based on compression of the lid 140 and the pin 170 between the PCBs 190 and 192. The interface contactor 10 can be designed or sized to facilitate a range of spacings between the PCBs 190 and 192 because the lid 140 is elastic and compressible to some extent. The pin 170 is also compressible to some extent. FIG. 1I illustrates an example of the interface contactor 10 in a compressed configuration.

The interface contactor 10 is generally designed to facilitate reduced dimensions in “H” as compared to other contactors or connectors that are currently available. In the example shown in FIG. 1H, the interface contactor 10 is positioned between the PCBs 190 and 192 without any additional components intervening or placed between them. However, in some cases, the interface contactor 10 can be positioned between PCBs along with other low profile interface contactor or connector components, such as contact buttons or other contactor interfaces.

FIG. 1I illustrates an example of the interface contactor 10 shown in FIG. 1A in a compressed state according to various embodiments of the present disclosure. FIG. 1I is a representative example and the interface contactor 10 can be compressed to a lesser extent in some cases. The interface contactor 10 can be compressed between PCBs, such as the PCBs 190 and 192 shown in FIG. 1H, for example, to facilitate a range of spacings between PCBs. The height “H3” of the lid 140 shown in FIG. 1I is smaller than the height “H1” of the lid 140 shown in FIG. 1G, due to compression of the lid 140. Although not illustrated in FIG. 1I, the lid 140 may bulge or expand outward to some extent when compressed. FIG. 1I also illustrates the top plunger pin 172 of the pin 170 being pressed down due to compression of the pin 170.

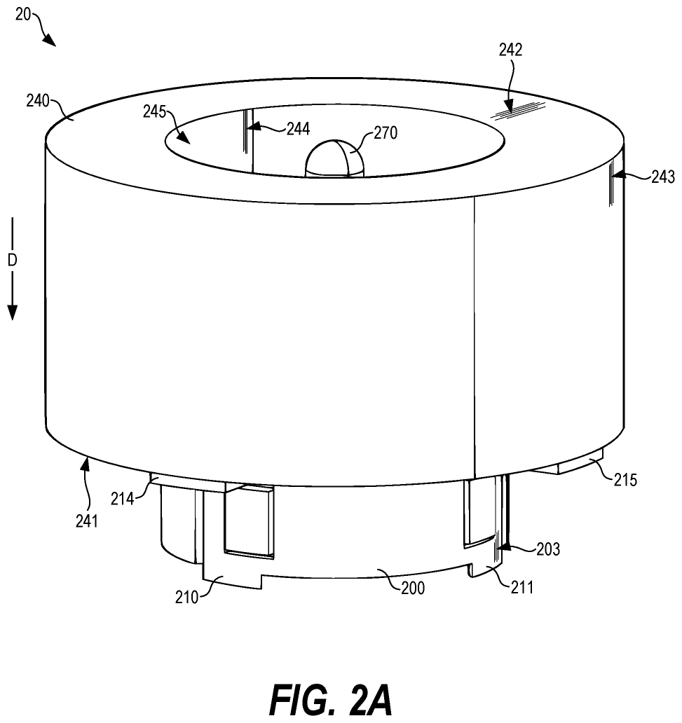

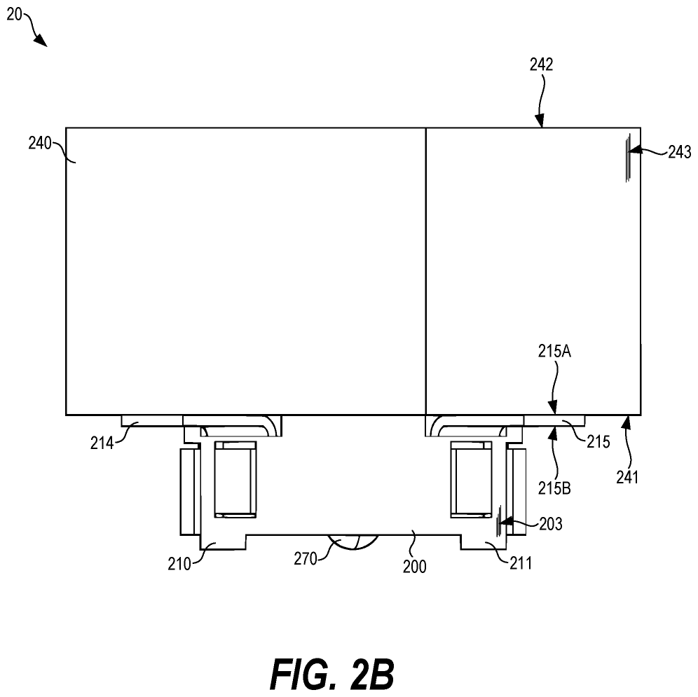

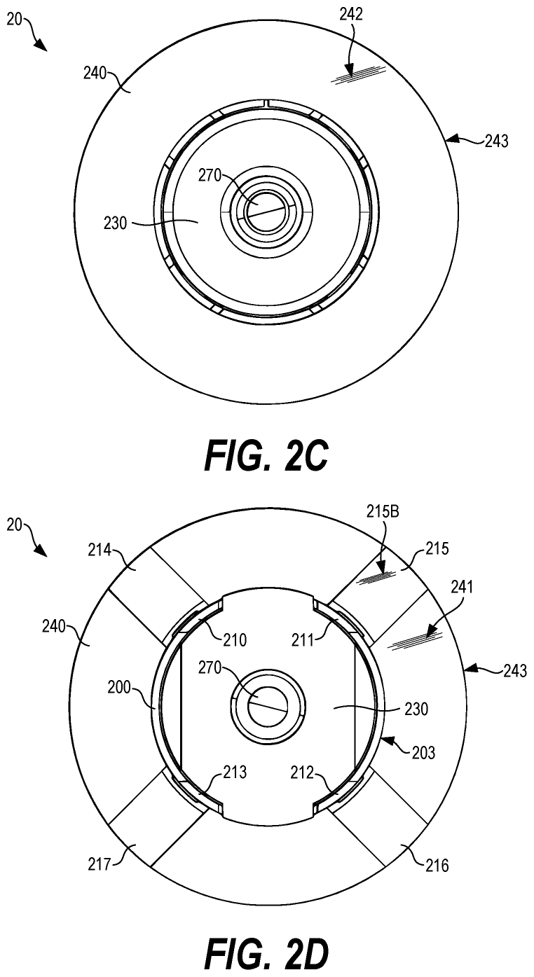

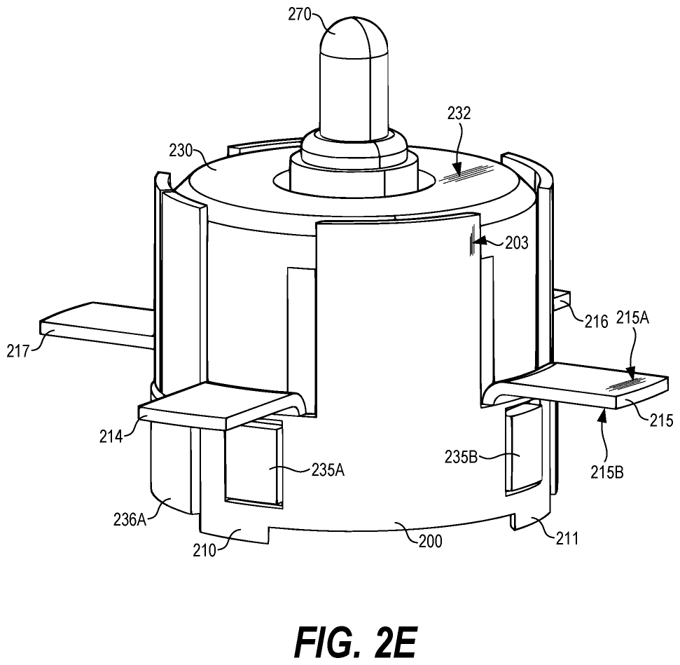

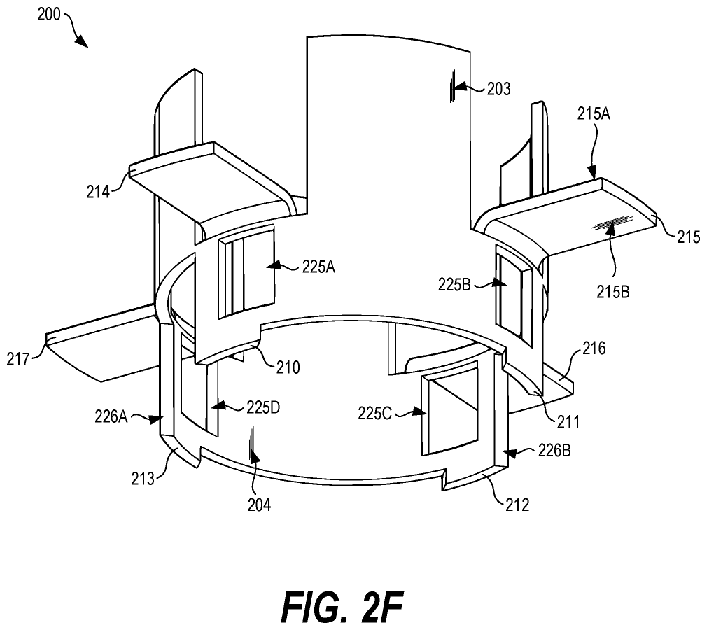

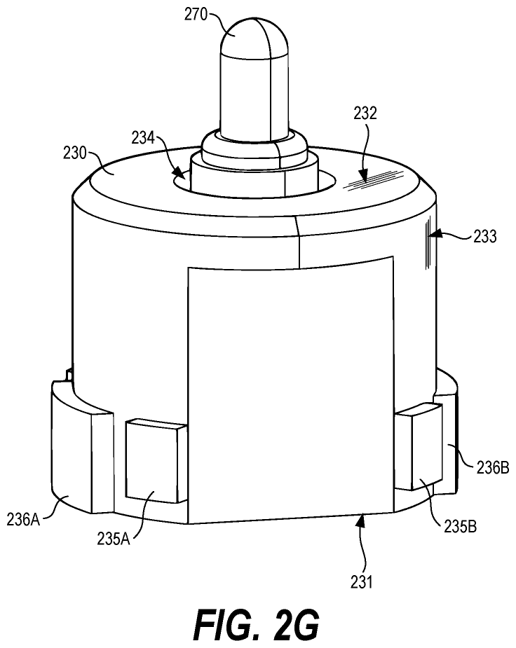

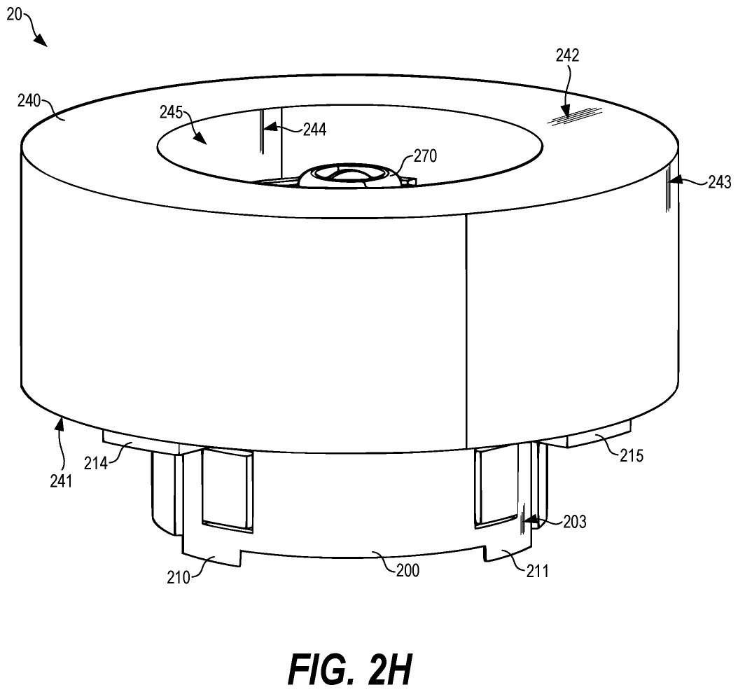

Turning to other examples, FIG. 2A illustrates a perspective view of another example board-to-board interface contactor 20 (“interface contactor 20”) according to various embodiments of the present disclosure. Additionally, FIG. 2B illustrates a side view, FIG. 2C illustrates a top-down view, and FIG. 2D illustrates a bottom-up view of the interface contactor 20 shown in FIG. 2A. The interface contactor 20 can be relied upon as a type of low profile board-to-board interface contactor for electrically coupling an RF signal, for example, between two different PCBs, as described herein. The interface contactor 20 can be compressed to some extent in the direction “D” shown in FIG. 2A when electrically coupled between PCBs, as also described below with reference to FIG. 2H. The interface contactor 20 is representative, not drawn to any particular scale, and is illustrated to provide context for the concepts of the low profile board-to-board interface contactors or connectors described herein.

Referring among FIGS. 2A-2D, the interface contactor 20 includes a contactor base housing 200 (also “housing 200”), an elastic and conductive lid 240 (also “lid 240”) over the housing 200, an insulating interposer 230 (also “interposer 230”), and a conductive pin 270 (also “pin 270”). FIG. 2E illustrates a perspective view of the housing 200, the insulating interposer 230, and the conductive pin 270 of the interface contactor 20 shown in FIG. 2A, with the lid 240 omitted from view. FIG. 2F illustrates a perspective view of the housing 200 of the interface contactor 20 shown in FIG. 2A, with the lid 240, the interposer 230, and the pin 270 omitted from view. FIG. 2G illustrates a perspective view of the interposer 230 and the pin 270 of the interface contactor 20 shown in FIG. 2A. When electrically coupled as a connector or contactor between PCBs, the housing 200 and the lid 240 can be electrically coupled to conductive ground, common, or drain contact pads on the PCBs, and the pin 270 can be electrically coupled to RF or other conductive signal traces or contact pads on the PCBs.

The housing 200 can be formed from an electrically-conductive, metallic material, such as brass, copper, gold, silver, or other conductive metals or alloys thereof. In one example, the housing 200 can be stamped or sheared out from a sheet of the electrically-conductive, metallic material, and then be bent or otherwise formed into the shape shown in FIG. 2A. The interposer 230 can be formed from an insulating material, such as a dielectric insulator. The interposer 230 can be formed from LCP, PE, PTFE, or other plastic or insulating materials using any suitable additive or subtractive manufacturing techniques, including molding, injection molding, printing, and other techniques.

The housing 200 is generally circular, when viewed from the top or the bottom, as best shown in FIGS. 2C and 2D, and includes an outer surface 203 and an inner surface 204 (see FIG. 2F). The outer surface 203 is cylindrical in shape, in the example shown. The housing 200 includes a number of legs 210-213 for mounting the interface contactor 20 at the lower end of the housing 200. The housing 200 includes four legs 210-213 in the example shown, and the legs 210-213 are spaced apart around the lower end of the housing 200. The housing 200 can include a different number of legs in other cases. For example, the housing 200 can include one, two, three, four, five, six, or more legs in other cases. The legs 210-213 are designed for a surface mount coupling to a PCB in the example shown. However, the housing 200 can include other types or styles of legs or lead configurations for mounting. For example, each of the legs 210-213 can be designed to have a toe extending radially outward, beyond the outer surface 203 of the housing 200. In other examples, the housing 200 can include through-hole posts for insertion through apertures of a PCB, such as plated apertures or vias in some cases.

Referring to FIGS. 2E and 2F, the housing 200 also includes a number of housing seat flanges 214-217. The housing 200 includes four housing seat flanges 214-217 in the example shown, and the housing seat flanges 214-217 are spaced apart around the housing 200. The housing seat flanges 214-217 are formed of the same material as the rest of the housing 200 and are conductive. The housing seat flanges 214-217 can be formed by cutting around and bending the flanges 214-217 down from the remainder of the cylindrical body of the housing 200. The housing 200 can include a different number of flanges in other cases. For example, the housing 200 can include two, three, four, five, six, or more flanges in other cases. Additionally, each of the housing seat flanges 214-217 can be wider or narrower than that shown.

Each of the housing seat flanges 214-217 extends radially away from the outer surface 203 of the housing 200 as shown in FIG. 2D. The housing seat flanges 214-217 extend to the outer cylindrical surface 243 of the lid 240 in the example shown, and each housing seat flange 214-217 includes a semicircular end edge. In other cases, the housing seat flanges 214-217 can extend radially away from the outer surface 203 of the housing 200 to a position short of (i.e., without meeting) the outer cylindrical surface 243 of the lid 240. Each of the housing seat flanges 214-217 includes an upper surface and a lower surface. The upper surface 215A and the lower surface 215B of the housing seat flange 215 are referenced in FIGS. 2E and 2F, and the housing seat flanges 214, 216, and 217 also include upper and lower surfaces.

The lid 240 can be embodied as a conductive foam material. The conductive foam material is elastic and compressible to some extent. As one example, the lid 240 can be embodied as a polyurethane foam multi-laminate including conductive materials, such as copper, nickel, or other conductive metals or materials. As another example, the lid 240 can be embodied as an acrylic adhesive multi-laminate including conductive materials, such as copper, nickel, or other conductive metals or materials. The lid 240 can be embodied as the P-SHIELD® brand PS-1356 or PS-1323 conductive foam manufactured by Polymer Science, Inc. of Monticello, Indiana, as one example, although other suitable types of conductive foams can be relied upon. The lid 240 is elastic and compressible from a pre-load height to a full-travel height over a range, such as between 0.5-1.5 mm, for example, based on an applied force, such as a force between 0.5 to 10 N.

The conductive foam material can be cut or otherwise formed into the cylindrical shape of the lid 240 shown in FIG. 2A. The lid 240 includes a central opening 245 that is cut or otherwise formed within the lid 240 as shown in FIG. 2A. The lid 240 includes a bottom surface 241 (see FIG. 2D), a top surface 242, the outer cylindrical surface 243, and an inner cylindrical surface 244. When the interface contactor 20 is assembled as shown in FIG. 2A, the bottom surface 241 of the lid 240 is positioned over and rests upon the upper surfaces of the housing seat flanges 214-217 of the housing 200. The inner cylindrical surface 144 of the lid 140 also contacts an upper portion of the outer cylindrical surface 203 of the of the housing 200 in this arrangement. Thus, based on contact between them, the lid 240 is electrically coupled to the housing 200. In some cases, the lid 240 can also be secured to the upper surfaces of the housing seat flanges 214-217 and the outer cylindrical surface 203 of the of the housing 200 using a conductive adhesive, such as conductive epoxy.

The pin 270 of the interface contactor 20 is formed from conductive materials, such as copper, brass, nickel, or other metals and is conductive. The pin 270 can be similar to or the same as the pin 170 described above in FIG. IF. The pin 270 can include a bottom plunger pin, a top plunger pin, a lower barrel rim, an upper barrel rim, and a pin barrel. The pin 270 can be spring-loaded and, although not visible, include a spring or other biasing member that extends within the pin barrel and between the top and bottom pin plungers. The spring applies a force to the top and bottom plunger pins. However, based on an external force, the top plunger pin can be pushed down into the pin barrel of the pin 270, overcoming the spring bias. In some cases, based on an external force, the bottom plunger pin can be pushed up into the pin barrel of the pin 270, overcoming the spring bias. In one example, the pin 270 can be embodied as a pogo-style pin, but other types and styles of pins can be relied upon.

Referring to FIG. 2F, the housing 200 also includes interlock apertures 225A-225D. The interlock apertures 225A-225D are formed through the housing 200 and extend through the outer surface 203 to an inner surface 204 of the housing 200. The interlock apertures 225A-225D are formed to help position and interlock the insulating interposer 230 within the housing 200, as described in further detail below. The housing 200 also includes interlock cutouts 226A and 226B. The interlock cutouts 226A and 226B are formed as cutouts from the bottom edge of the housing 200. The interlock cutouts 226A and 226B are also formed to help position and interlock the insulating interposer 230 within the housing 200, as described in further detail below. In other examples, the number, sizes, shapes, and positions of the interlock apertures 225A-225D and the interlock cutouts 226A and 226B can vary as compared to that shown.

Referring to FIG. 2G, the interposer 230 includes a bottom surface 231, a top surface 232, and an outer surface 233, among other edges and surfaces. The outer surface 233 of the interposer 230 is, at least in part, cylindrical in the example shown. A central aperture 234 extends through the interposer 230, and the pin 270 extends through the central aperture 234. The central aperture 234 extends from a first opening in the top surface 232, through the interposer 230, and to a second opening in the bottom surface 231 of the interposer 230. The pin 270 is positioned, extends within, and occupies the central aperture 234. As shown in FIGS. 2C and 2D, opposite ends of the pin 270 are exposed both at a top of the interposer 230 and at bottom of the interposer 230.

The interposer 230 includes interlock extensions 235A and 235B, among others, which extend out and beyond from the outer surface 233 of the interposer 230. The interlock extensions 235A and 235B are seated and positioned into the interlock apertures 225A and 225B of the housing 200 when the interposer 230 is positioned within the housing 200. A mechanical interference between the edges of the interlock extensions 235A and 235B and the interlock apertures 225A and 225B of the housing 200 maintains the position of the interposer 230 within the housing 200. The mechanical interference prevents the interposer 230 from moving or rotating with respect to the housing 200 when the interface contactor 20 is assembled. The interposer 230 also includes the interlock extensions 236A and 236B. The interlock extensions 236A and 236B are seated and positioned into the interlock cutouts 226A and 226B of the housing 200, when the interposer 230 is positioned within the housing 200. A mechanical interference between the edges of the interlock extensions 236A and 236B and the interlock cutouts 226A and 226B of the housing 200 maintains the position of the interposer 230.

The interface contactor 20 provides a first conductive ground, common, or drain pathway between the top surface 242 of the lid 240 and the bottom surfaces of the legs 210-213 of the housing 200. The interface contactor 20 also provides a second conductive pathway, such as for RF signals, through the pin 270. The pin 270 is electrically isolated from the lid 240 and the housing 200 by the interposer 230, which is insulating. Thus, the interface contactor 20 provides two separate conductive pathways for electrical interface purposes.

The overall height of the interface contactor 20 (i.e., as measured from the top to the bottom of the page in FIG. 2B) can range in various embodiments, such as between 2.5 mm to 7.5 mm, although the interface contactor 20 can be designed to other sizes. It should be appreciated, in any case, that the interface contactor 20 is capable of providing an electrical interface over a range of spacings or dimensions between two PCBs. In that context, the interface contactor 20 can be positioned between two PCBs, similar to the PCBs 190 and 192 shown in FIG. 1H. The interface contactor 20 can be compressed to some extent in the direction “D” shown in FIG. 2A when electrically coupled between PCBs. The interface contactor 20 is also capable of accommodating a tilt angle φ between PCBs, due to the elastic and compressible nature of the lid 240.

FIG. 2H illustrates an example of the interface contactor 20 shown in FIG. 2A in a compressed state according to various embodiments of the present disclosure. FIG. 2H is a representative example, and the interface contactor 20 can be compressed to a lesser extent in some cases. The interface contactor 20 can be compressed between PCBs, such as the PCBs 190 and 192 shown in FIG. 1H, for example, to facilitate a range of spacings between PCBs. Although not illustrated in FIG. 2H, the lid 240 may bulge or expand outward to some extent when compressed. FIG. 2H also illustrates the top plunger pin of the pin 270 being pressed down due to compression of the pin 270.

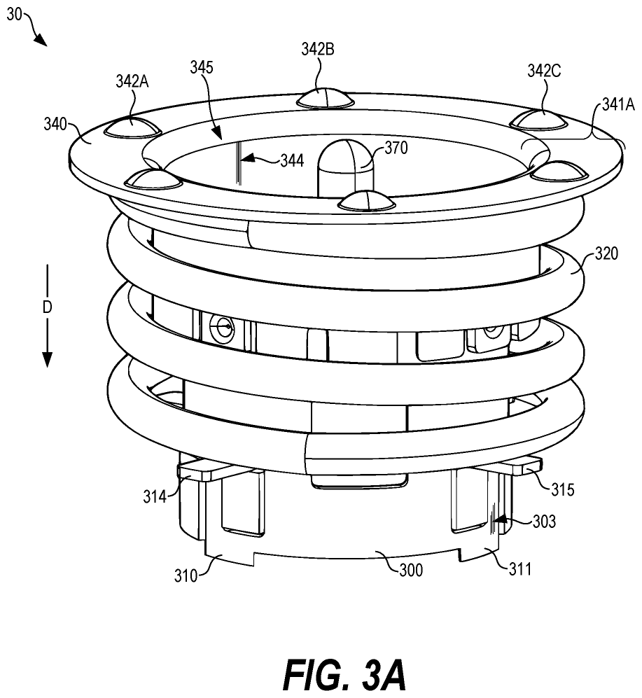

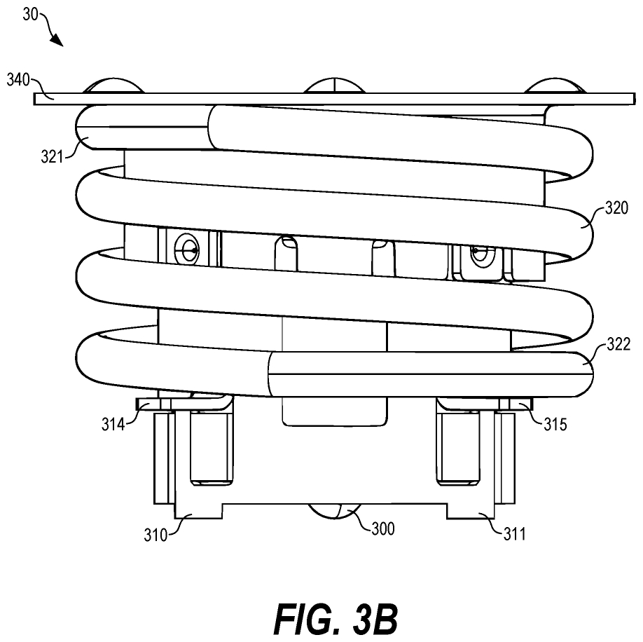

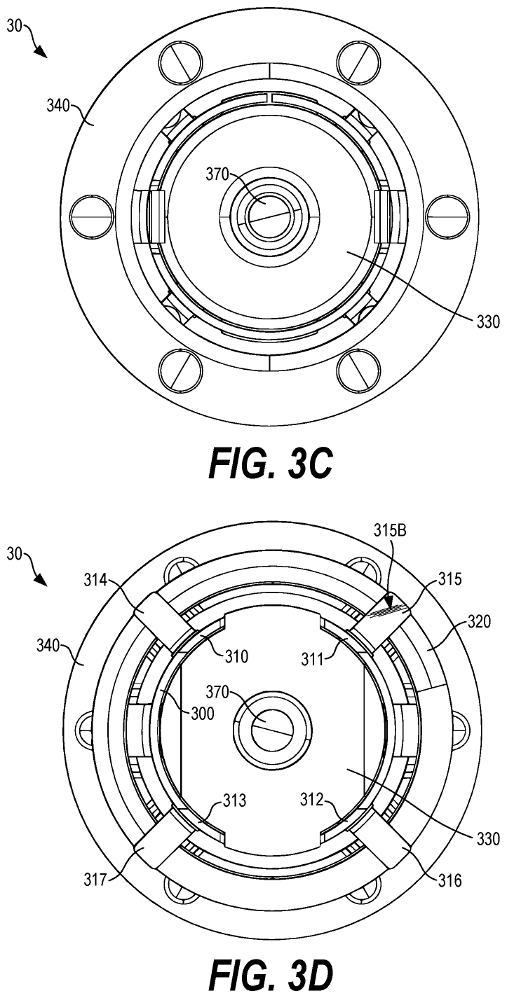

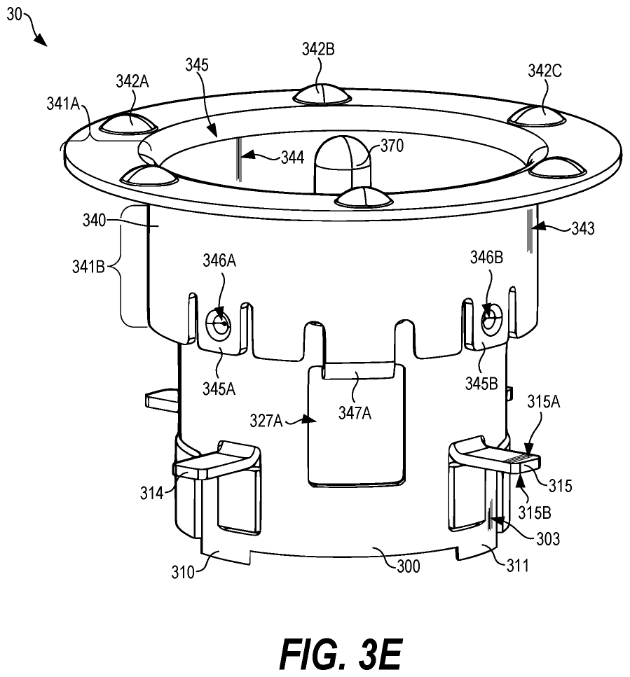

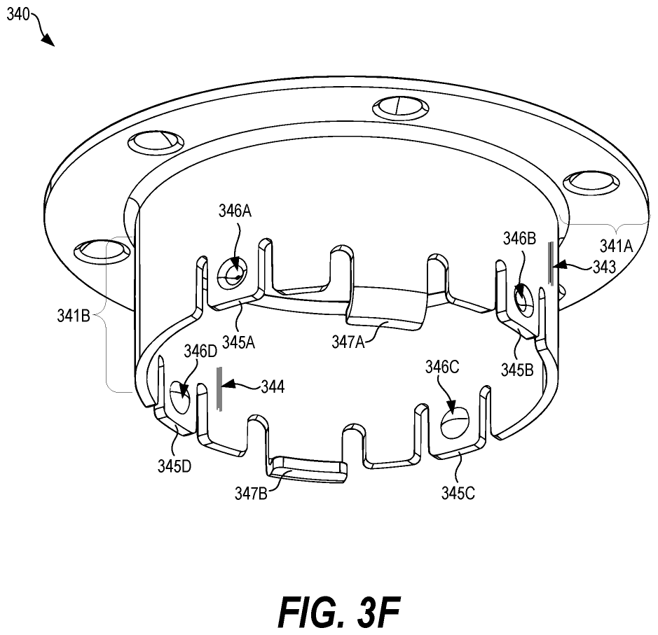

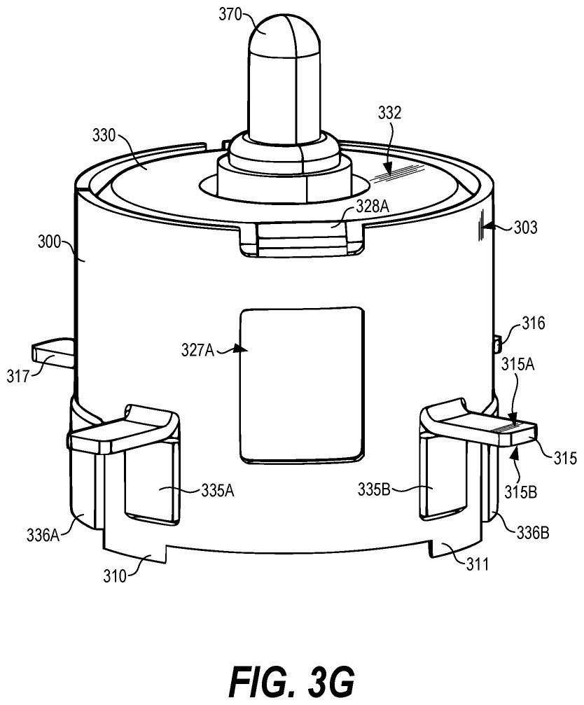

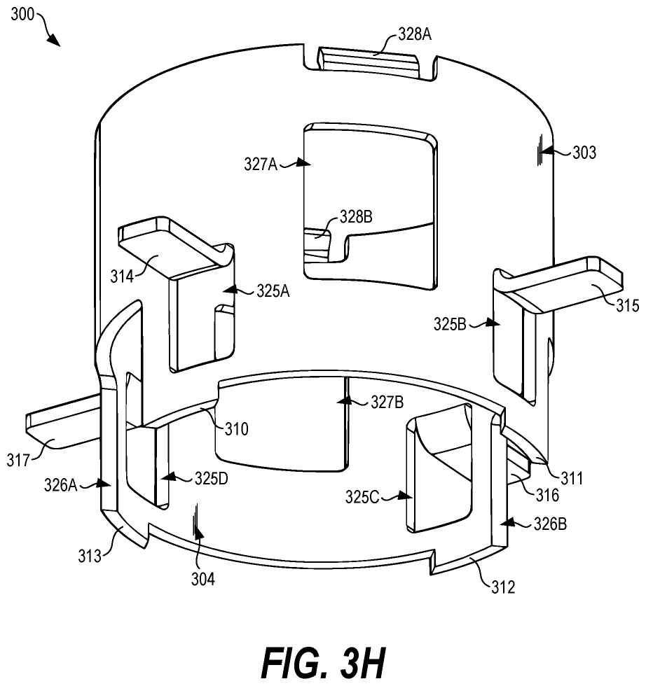

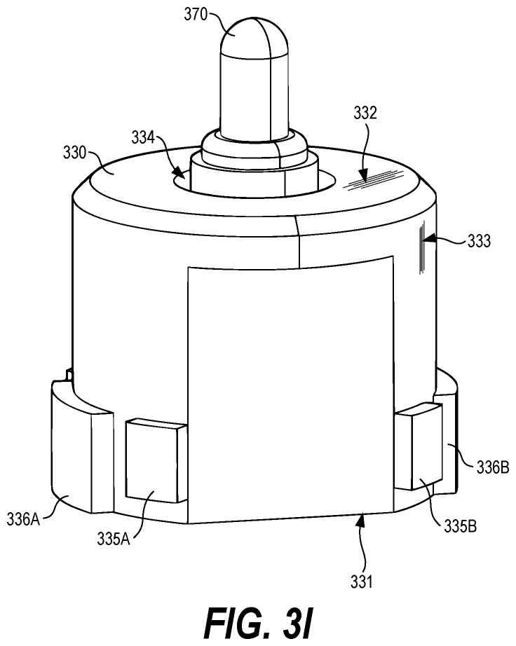

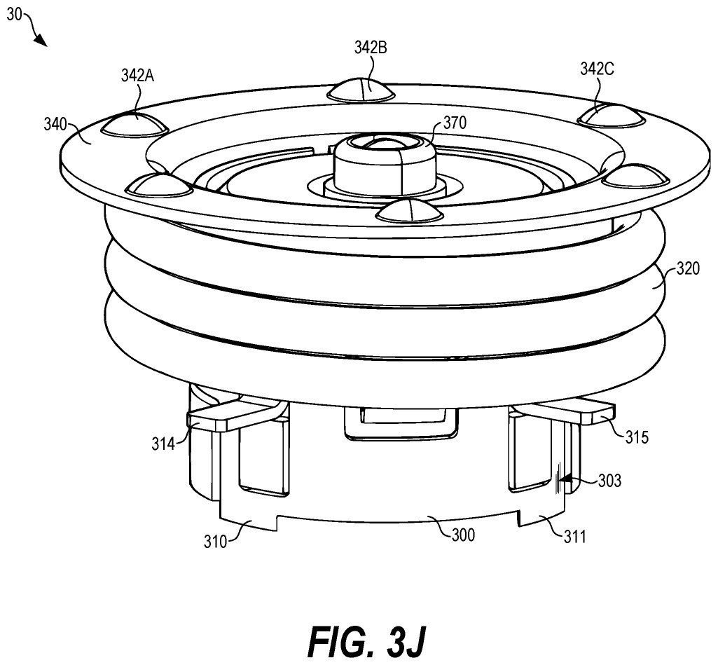

Turning to other examples, FIG. 3A illustrates a perspective view of another example board-to-board interface contactor 30 (“interface contactor 30”) according to various embodiments of the present disclosure. Additionally, FIG. 3B illustrates a side view, FIG. 3C illustrates a top-down view, and FIG. 3D illustrates a bottom-up view of the interface contactor 30 shown in FIG. 3A. The interface contactor 30 can be relied upon as a type of low profile board-to-board interface contactor for electrically coupling an RF signal, for example, between two different PCBs, as described herein. The interface contactor 30 can be compressed to some extent in the direction “D” shown in FIG. 3A when electrically coupled between PCBs, as also described below with reference to FIG. 3J. The interface contactor 30 is representative, not drawn to any particular scale, and is illustrated to provide context for the concepts of the low profile board-to-board interface contactors or connectors described herein.

Referring among FIGS. 3A-3D, the interface contactor 30 includes a contactor base housing 300 (also “housing 300”), a spring 320 positioned around the housing 300, a contactor shield 340 positioned around and over the housing 300, an insulating interposer 330 (also “interposer 330”), and a conductive pin 370 (also “pin 370”). FIG. 3E illustrates a perspective view of the housing 300, the contactor shield 340, and the conductive pin 370 of the interface contactor 30 shown in FIG. 3A, with the spring 320 omitted from view. FIG. 3F illustrates a perspective view of the contactor shield 340 of the interface contactor 30 shown in FIG. 3A, with the remaining components omitted from view. FIG. 3G illustrates a perspective view of the housing 300, the interposer 330, and the pin 370 of the interface contactor 30 shown in FIG. 3A, with the spring 320 and the contactor shield 340 omitted from view.

FIG. 3H illustrates a perspective view of the housing 300 of the interface contactor 30 shown in FIG. 3A, with the remaining components omitted from view. FIG. 31 illustrates a perspective view of the interposer 330 and the pin 370 of the interface contactor 30 shown in FIG. 3A, with the remaining components omitted from view. When electrically coupled as a connector or contactor between PCBs, the housing 300 and the contactor shield 340 can be electrically coupled to conductive ground, common, or drain contact pads on the PCBs, and the pin 370 can be electrically coupled to RF or other conductive signal traces or contact pads on the PCBs.

The housing 300 can be formed from an electrically-conductive, metallic material, such as brass, copper, gold, silver, or other conductive metals or alloys thereof. In one example, the housing 300 can be stamped or sheared out from a sheet of the electrically-conductive, metallic material, and then be bent or otherwise formed into the shape shown in FIG. 3A. The contactor shield 340 can also be formed from an electrically-conductive, metallic material, such as brass, copper, gold, silver, or other conductive metals or alloys thereof. In one example, the contactor shield 340 can be stamped or sheared out from a sheet of the electrically-conductive, metallic material, and then be bent or otherwise formed into the shape shown in FIG. 3A. The interposer 330 can be formed from an insulating material, such as a dielectric insulator. The interposer 330 can be formed from LCP, PE, PTFE, or other plastic or insulating materials using any suitable additive or subtractive manufacturing techniques, including molding, injection molding, printing, and other techniques.

The spring 320 can be embodied as a helical coil spring formed from an elastic steel, stainless steel, or other suitable material capable of storing potential energy based on compression. The spring 320 can be plated with one or more metals in some cases, such as copper, nickel, tin, gold, or another plating metal or combination of plating metals. The spring 320 is sized to fit around (e.g., helically wrap around) the contactor shield 340 and the housing 300. Referring to FIG. 3B, the spring 320 includes an upper flat extension 321 and a lower flat extension 322, with a remainder of the turns of the helical coil spring extending between them. The spring 320 includes between three and four complete helical turns in the example shown, but the spring 320 can be formed to have additional or fewer turns in other cases. The spring 320 is elastic and compressible from a pre-load height to a full-travel height over a range, such as between 0.5-1.5 mm, for example, based on an applied force, such as a force between 0.5 to 10 N.

The housing 300 is generally circular, when viewed from the top or the bottom, as best shown in FIGS. 3C and 3D, and includes an outer surface 303 and an inner surface 304 (see FIG. 3H). The outer surface 203 is cylindrical in shape in the example shown. The housing 300 includes a number of legs 310-313 for mounting the interface contactor 30 at the lower end of the housing 300. The housing 300 includes four legs 310-313 in the example shown, and the legs 310-313 are spaced apart around the lower end of the housing 300. The housing 300 can include a different number of legs in other cases. For example, the housing 300 can include one, two, three, four, five, six, or more legs in other cases. The legs 310-313 are designed for a surface mount coupling to a PCB in the example shown. However, the housing 300 can include other types or styles of legs or lead configurations for mounting. For example, each of the legs 310-313 can be designed to have a toe extending radially outward beyond the outer surface 303 of the housing 300. In other examples, the housing 300 can include through-hole posts for insertion through apertures of a PCB, such as plated apertures or vias in some cases.

Referring to FIGS. 3E, 3G, and 3H, the housing 300 also includes a number of spring seat flanges 314-317. The housing 300 includes four spring seat flanges 314-317 in the example shown, and the spring seat flanges 314-317 are spaced apart around the housing 300. The spring seat flanges 314-317 can be formed by cutting around and bending the flanges 314-317 down from the remainder of the cylindrical body of the housing 300. The housing 300 can include a different number of flanges in other cases. For example, the housing 300 can include two, three, four, five, six, or more flanges in other cases. Additionally, each of the spring seat flanges 314-317 can be wider or narrower than that shown. Each of the spring seat flanges 314-317 extends radially away from the outer surface 303 of the housing 300. Each of the spring seat flanges 314-317 includes an upper surface and a lower surface. The upper surface 315A and the lower surface 315B of the spring seat flange 315 are referenced in FIGS. 3E and 3G, and the spring seat flanges 314, 316, and 317 also include upper and lower surfaces.

The contactor shield 340 is generally circular when viewed from the top or the bottom, as best shown in FIGS. 3C and 3D. Referring between FIGS. 3E and 3F, the contactor shield 340 includes an upper rim 341A, a lower barrel 341B, a central opening 345 extending within the upper rim 341A and the lower barrel 341B, an outer surface 343 of the lower barrel 341B, and an inner surface 344 of the lower barrel 341B. The upper rim 341A extends radially away from the outer surface 343. The upper rim 341A includes a number of contact bumps, including the contact bumps 342A-342C referenced in FIG. 3E, among others. The contact bumps 342A-342C arc raised bumps that extend up from a top surface of the upper rim 341A. The contact bumps 342A-342C can be evenly spaced apart in a concentric arrangement as shown, although other spacings or placements of the contact bumps 342A-342C can be relied upon. The contact bumps 342A-342C can be electrically coupled to conductive ground, common, or drain contact pads on a PCB.

The contactor shield 340 is concentrically positioned over and around the top end of the housing 300, as best shown in FIG. 3E. The lower barrel 341B of the contactor shield 340 is nominally larger than the housing 300 to permit clearance for movement between them. The contactor shield 340 is arranged and interlocked over the housing 300 in a spring-biased arrangement based on the spring 320, as described in further detail below. The contactor shield 340 can be pushed down in the direction “D” (see FIG. 3A) against the spring bias provided by the spring 320. In that case, the contactor shield 340 will cover more of the housing 300 than that shown in FIG. 3A, as the contactor shield 340 will be pushed down further over the housing 300. Thus, the interface contactor 30 is compressible to some extent.

The contactor shield 340 also includes contact tabs 345A-345D formed in the bottom edge of the lower barrel 341B. Each of the contact tabs 345A-345D includes a contact bump 346A-346D, respectively. The contact tabs 345A-345D can flex or bend to some extent, and the inner surfaces of the contact bumps 346A-346D are configured to contact the outer surface 303 of the housing 300 when the interface contactor 30 is assembled. The contact tabs 345A-345D provide an electrical coupling between the contactor shield 340 and the housing 300.

The contactor shield 340 also includes interlock arms 347A and 347B. The interlock arms 347A and 347B fit into extension channels 327A and 327B (see FIG. 3H) of the housing 300. The ends of the interlock arms 347A and 347B are curved or bent toward the center of the contactor shield 340, as best shown in FIG. 3F. When the contactor shield 340 is positioned over the housing 300, a mechanical interference between the edges of the curved ends of the interlock arms 347A and 347B and the edges of the extension channels 327A and 327B maintains the contactor shield 340 in position over the housing 300. That is, the mechanical interference prevents the contactor shield 340 from rotating with respect to the housing 300, beyond a nominal clearance between the interlock arms 347A and 347B and the extension channels 327A and 327B. However, the contactor shield 340 can still move in the direction “D” shown in FIG. 3A, as the curved ends of the interlock arms 347A and 347B can shift or slide along the lengths of the extension channels 327A and 327B. The lengths of the interlock arms 347A and 347B and the extension channels 327A and 327B can vary as compared to that shown, to determine or set the range of movement or travel between the contactor shield 340 and the housing 300.

Referring to FIG. 3H, the housing 300 also includes interlock apertures 325A-325D. The interlock apertures 325A-325D are formed through the housing 300 and extend through the outer surface 303 to an inner surface 304 of the housing 300. The interlock apertures 325A-325D are formed to help position and interlock the insulating interposer 330 within the housing 300. The housing 300 also includes interlock cutouts 326A and 326B. The interlock cutouts 326A and 326B are formed as cutouts from the bottom edge of the housing 300. The interlock cutouts 326A and 326B are also formed to help position and interlock the insulating interposer 330 within the housing 300. The housing 300 also includes catch hooks 328A and 328B. The catch hooks 328A and 328B curl around and can contact the top end of the insulating interposer 230, helping to secure the insulating interposer 330 into position with the housing 300. In other examples, the number, sizes, shapes, and positions of the interlock apertures 325A-325D, the interlock cutouts 326A and 326B, and the catch hooks 328A and 328B of the housing 300 can vary as compared to that shown.

When the interface contactor 30 is assembled, the spring 320 is positioned around (e.g., helically wrapped around) the lower barrel 341B of the contactor shield 340 and an upper portion of the housing 300, above the spring seat flanges 314-317. The lower end of the spring 320, including the lower flat extension 322, rests upon one or more of the spring seat flanges 314-317 of the housing 300. The upper end of the spring 320, including the upper flat extension 321, pushes up against the bottom surface of the upper rim 341A of the contactor shield 340. The spring 320 maintains the interface contactor 30 in the extended configuration shown in FIGS. 3A and 3B without an external force applied to the interface contactor 30. An external force applied down against the top of the contactor shield 340 in the direction “D” can overcome the spring bias of the spring 320 to compress the interface contactor 30, as shown in FIG. 3J.

Referring to FIG. 31, the interposer 330 includes a bottom surface 331, a top surface 332, and an outer surface 333, among other edges and surfaces. The outer surface 333 of the interposer 330 is cylindrical, at least in part, in the example shown. A central aperture 334 extends through the interposer 330, and the pin 370 extends through the central aperture 334. The central aperture 334 extends from a first opening in the top surface 332, through the interposer 330, and to a second opening in the bottom surface 331 of the interposer 230. The pin 370 is positioned, extends within, and occupies the central aperture 334. As shown in FIGS. 3C and 3D, opposite ends of the pin 370 are exposed both at a top of the interposer 330 and at bottom of the interposer 330.

The interposer 330 includes interlock extensions 335A and 335B, among others, which extend out and beyond from the outer surface 333 of the interposer 330. The interlock extensions 335A and 335B are seated and positioned into the interlock apertures 325A and 325B of the housing 300 when the interposer 330 is positioned within the housing 300, as shown in FIG. 3G. A mechanical interference between the edges of the interlock extensions 335A and 335B and the interlock apertures 325A and 325B of the housing 200 maintains the position of the interposer 330 within the housing 300. The mechanical interference prevents the interposer 330 from moving or rotating with respect to the housing 300 when the interface contactor 30 is assembled. The interposer 330 also includes the interlock extensions 336A and 336B. The interlock extensions 336A and 336B are seated and positioned into the interlock cutouts 326A and 326B of the housing 300, when the interposer 330 is positioned within the housing 300. A mechanical interference between the edges of the interlock extensions 336A and 336B and the interlock cutouts 326A and 326B of the housing 300 maintains the position of the interposer 330.

The pin 370 of the interface contactor 30 is formed from conductive materials, such as copper, brass, nickel, or other metals and is conductive. The pin 370 can be similar to or the same as the pin 170 described above in FIG. 1F. The pin 370 can include a bottom plunger pin, a top plunger pin, a lower barrel rim, an upper barrel rim, and a pin barrel. The pin 370 can be spring-loaded and, although not visible, include a spring or other biasing member that extends within the pin barrel and between the top and bottom pin plungers. The spring applies a force to the top and bottom plunger pins. However, based on an external force, the top plunger pin can be pushed down into the pin barrel of the pin 370, overcoming the spring bias. In some cases, based on an external force, the bottom plunger pin can be pushed up into the pin barrel of the pin 370, overcoming the spring bias. In one example, the pin 370 can be embodied as a pogo-style pin, but other types and styles of pins can be relied upon.

The interface contactor 30 provides a first conductive ground, common, or drain pathway between the upper rim 341A of the contactor shield 340 and the bottom surfaces of the legs 310-313 of the housing 300. The interface contactor 30 also provides a second conductive pathway, such as for RF signals, through the pin 370. The pin 370 is electrically isolated from the contactor shield 340 and the housing 300 by the interposer 330, which is insulating. Thus, the interface contactor 30 provides two separate conductive pathways for electrical interface purposes.

The overall height of the interface contactor 30 (i.e., as measured from the top to the bottom of the page in FIG. 3B) can range in various embodiments, such as between 2.5 mm to 7.5 mm, although the interface contactor 30 can be designed to other sizes. It should be appreciated, in any case, that the interface contactor 30 is capable of providing an electrical interface over a range of spacings or dimensions between two PCBs. In that context, the interface contactor 30 can be positioned between two PCBs, similar to the PCBs 190 and 192 shown in FIG. 1H. The interface contactor 30 can be compressed to some extent in the direction “D” shown in FIG. 3A when electrically coupled between PCBs. The interface contactor 30 is also capable of accommodating a tilt angle φ between PCBs.

FIG. 3J illustrates an example of the interface contactor 30 shown in FIG. 3A in a compressed state according to various embodiments of the present disclosure. FIG. 3J is a representative example, and the interface contactor 30 can be compressed to a lesser extent in some cases. The interface contactor 30 can be compressed between PCBs, such as the PCBs 190 and 192 shown in FIG. 1H, for example, to facilitate a range of spacings between PCBs. FIG. 3J also illustrates the top plunger pin of the pin 370 being pressed down due to compression of the pin 370.

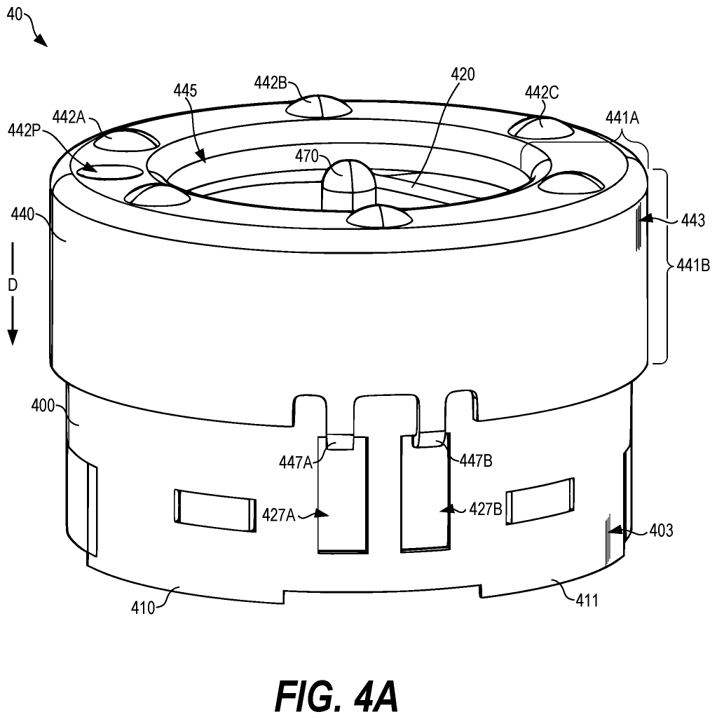

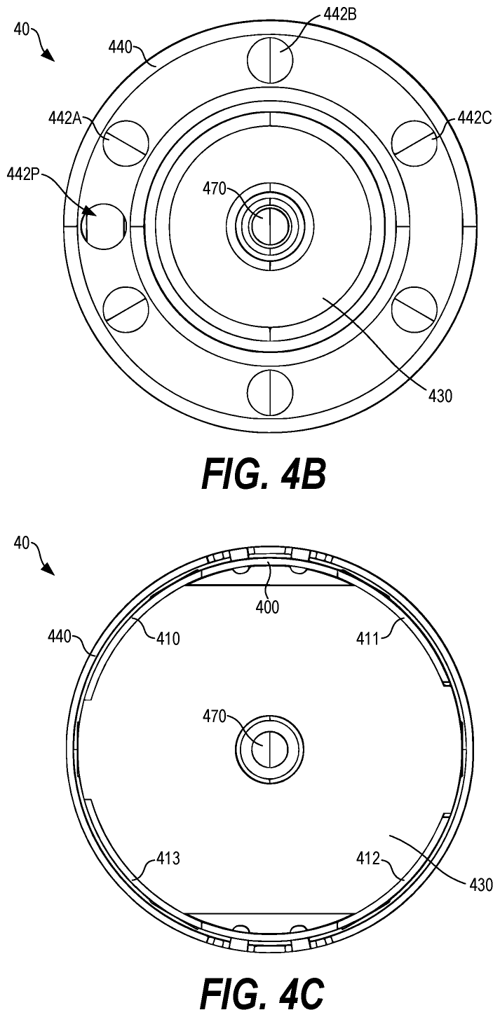

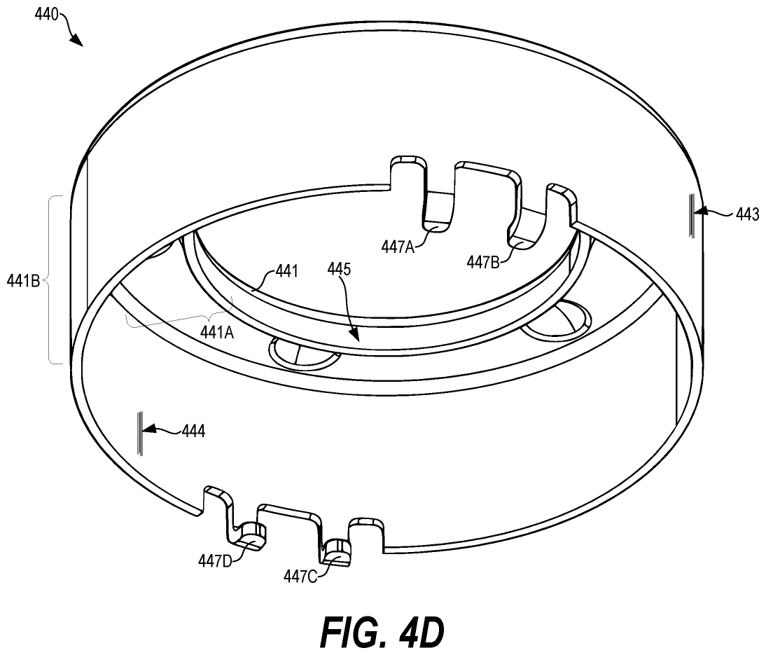

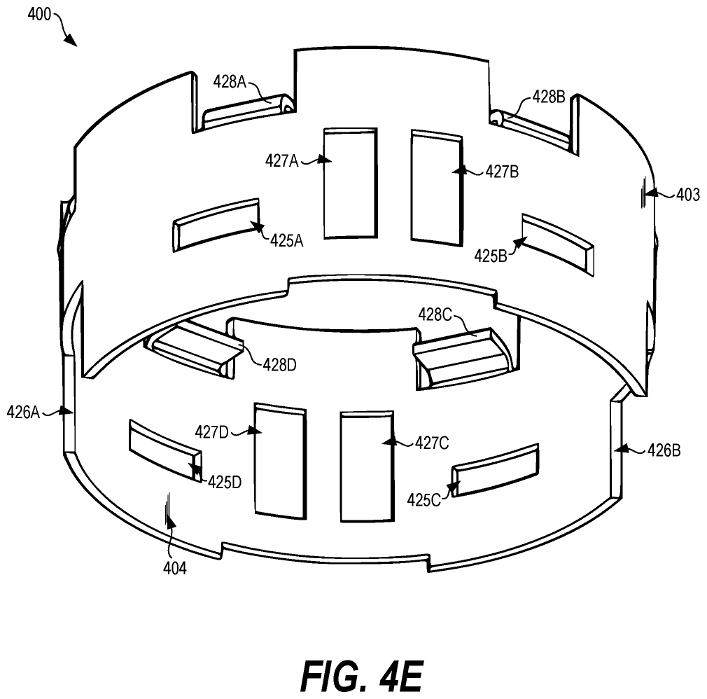

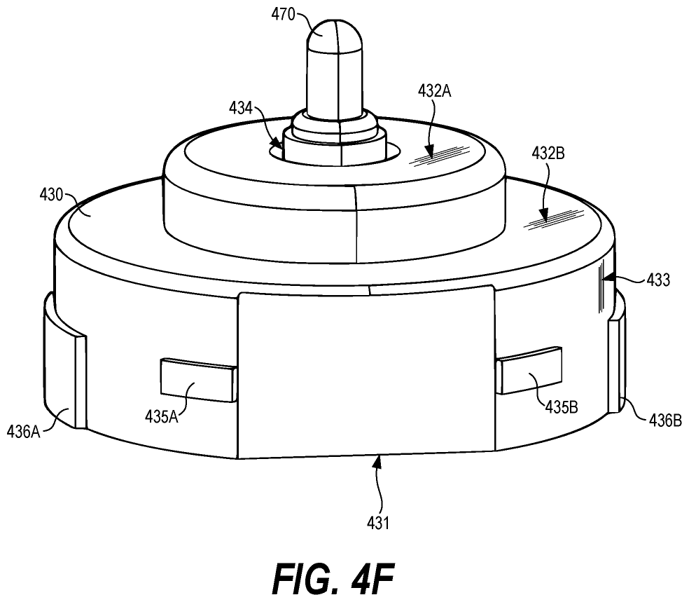

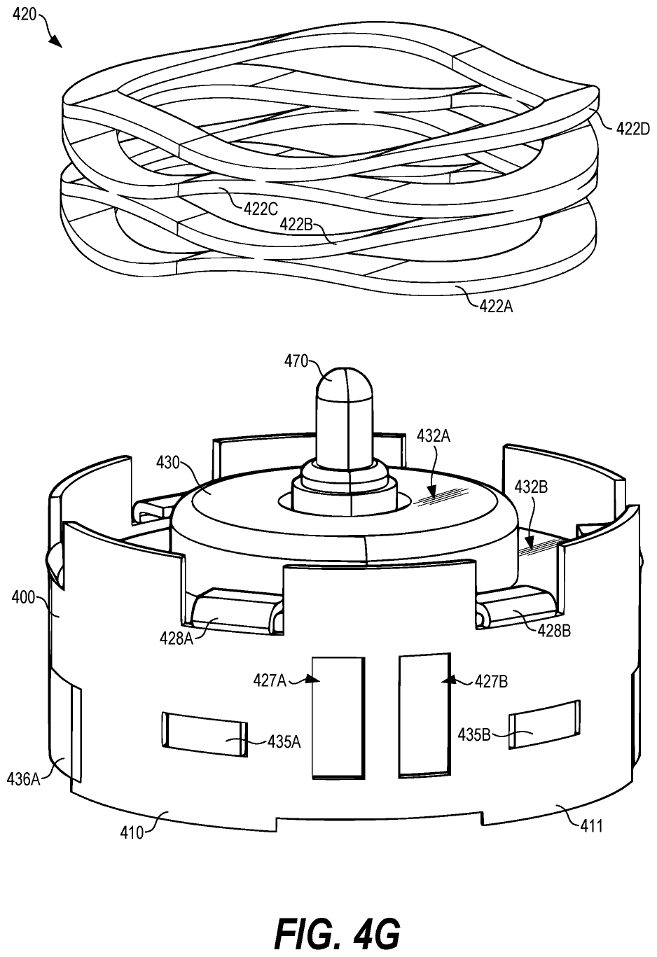

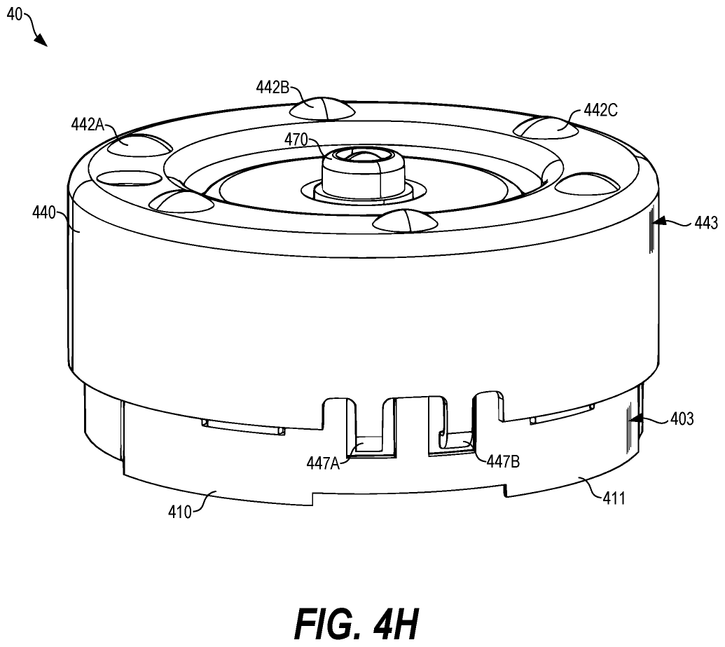

Turning to other examples, FIG. 4A illustrates a perspective view of another example board-to-board interface contactor 40 (“interface contactor 40”) according to various embodiments of the present disclosure. Additionally, FIG. 4B illustrates a top-down view and FIG. 4C illustrates a bottom-up view of the interface contactor 40 shown in FIG. 4A. The interface contactor 40 can be relied upon as a type of low profile board-to-board interface contactor for electrically coupling an RF signal, for example, between two different PCBs, as described herein. The interface contactor 40 can be compressed to some extent in the direction “D” shown in FIG. 4A when electrically coupled between PCBs, as also described below with reference to FIG. 4H. The interface contactor 40 is representative, not drawn to any particular scale, and is illustrated to provide context for the concepts of the low profile board-to-board interface contactors or connectors described herein.

Referring among FIGS. 4A-4C, the interface contactor 40 includes a shield body housing 400 (also “housing 100”), a shield lid 440, a spring 420, an insulating interposer 430 (also “interposer 430”), and a conductive pin 470 (also “pin 470”). FIG. 4D illustrates a perspective view of the shield lid 440 of the interface contactor 40 shown in FIG. 4A. FIG. 4E illustrates a perspective view of the housing 400 of the interface contactor 40 shown in FIG. 4A. FIG. 4F illustrates a perspective view of the insulating interposer 430 and pin 470 of the interface contactor 40 shown in FIG. 4A. FIG. 4G illustrates a perspective view of the spring 420, housing 400, interposer 430, and pin 470 of the interface contactor 40 shown in FIG. 4A. When electrically coupled as a connector or contactor between PCBs, the housing 400 and the shield lid 440 can be electrically coupled to conductive ground, common, or drain contact pads on the PCBs, and the pin 470 can be electrically coupled to RF or other conductive signal traces or contact pads on the PCBs.

The housing 400 can be formed from an electrically-conductive, metallic material, such as brass, copper, gold, silver, or other conductive metals or alloys thereof. In one example, the housing 400 can be stamped or sheared out from a sheet of the electrically-conductive, metallic material, and then be bent or otherwise formed into the shape shown in FIG. 4A. The shield lid 440 can also be formed from an electrically-conductive, metallic material, such as brass, copper, gold, silver, or other conductive metals or alloys thereof. In one example, the shield lid 440 can be stamped or sheared out from a sheet of the electrically-conductive, metallic material, and then be bent or otherwise formed into the shape shown in FIG. 4A. The interposer 430 can be formed from an insulating material, such as a dielectric insulator. The interposer 430 can be formed from LCP, PE, PTFE, or other plastic or insulating materials using any suitable additive or subtractive manufacturing techniques, including molding, injection molding, printing, and other techniques.

The spring 420 can be embodied as a wave washer spring formed from an elastic steel, stainless steel, or other suitable material capable of storing potential energy based on compression. The spring 420 can be plated with one or more metals in some cases, such as copper, nickel, tin, gold, or another plating metal or combination of plating metals. The spring 420 is sized to fit within the housing 400 as described in further detail below. Other aspects of the spring 420 are described below with reference to FIG. 4G.

The housing 400 is generally circular, when viewed from the top or the bottom, as best shown in FIGS. 4B and 4C, and includes an outer surface 403 and an inner surface 404 (see FIG. 4E). The outer surface 403 is cylindrical in shape, in the example shown. The housing 400 includes a number of legs 410-413 for mounting the interface contactor 40 at the lower end of the housing 400. The housing 400 includes four legs 410-413 in the example shown, and the legs 410-413 are spaced apart around the periphery of the lower end of the housing 400. The housing 400 can include a different number of legs in other cases. For example, the housing 400 can include one, two, three, four, five, six, or more legs in other cases. The legs 410-413 are designed for a surface mount coupling to a PCB in the example shown. However, the housing 400 can include other types or styles of legs or lead configurations for mounting. For example, each of the legs 410-413 can be designed to have a toe extending radially outward beyond the outer surface 403 of the housing 400. In other examples, the housing 400 can include through-hole posts for insertion through apertures of a PCB, such as plated apertures or vias in some cases.

The shield lid 440 is also generally circular, when viewed from the top or the bottom, as best shown in FIGS. 4B and 4C, and includes an outer surface 443 and an inner surface 444 (sec FIG. 4D). Referring to FIG. 4D, the shield lid 440 includes an upper rim 441A, a lower barrel 441B, a central opening 445, an outer surface 443 of the lower barrel 441B, and an inner surface 444 of the lower barrel 441B. The upper rim 441A extends radially inward from the outer surface 443 toward the center of the shield lid 440. The upper rim 441A includes a number of contact bumps, including contact bumps 442A-442C (see FIG. 4A), among others. The contact bumps 442A-442C are raised bumps that extend up from a top surface of the upper rim 441A. The contact bumps 442A-442C can be evenly spaced apart in a concentric arrangement as shown, although other spacings or placements of the contact bumps 442A-442C can be relied upon. The contact bumps 442A-442C can be electrically coupled to conductive ground, common, or drain contact pads on a PCB.

The upper rim 441A also includes an orientation aperture 442P. The orientation aperture 442P is an opening through the upper rim 441A and can be used as a reference point for automated pick-and-place operations and other purposes. The location of the orientation aperture 442P can vary as compared to that shown, and the shield lid 440 can include additional orientation apertures in some cases. Additionally, other interface contactors described herein can include orientation apertures. For example, the interface contactor 30 can include one or more orientation apertures in the upper rim 341A.

The shield lid 440 is concentrically positioned over and around the top end of the housing 400, as best shown in FIG. 4A. The lower barrel 441B of the shield lid 440 is nominally larger than the housing 400 to permit clearance for movement between them. The shield lid 440 is arranged and interlocked over the housing 400 in a spring-biased arrangement based on the spring 420, as described in further detail below. The shield lid 440 can be pushed down in the direction “D” against the spring bias provided by the spring 420. In that case, the shield lid 440 will cover more of the housing 400 than that shown in FIG. 4A, as the shield lid 440 will be pushed down further over the housing 400. Thus, the interface contactor 40 is compressible to some extent.

Referring to FIG. 4D, the shield lid 440 includes interlock arms 447A-447D. The interlock arms 447A-447D fit into extension channels 427A-427D (see FIG. 4E) of the housing 400. The ends of the interlock arms 447A-447D are curved or bent toward the center of the shield lid 440. When the shield lid 440 is positioned over the housing 400, a mechanical interference between the edges of the curved ends of the interlock arms 447A-447D and the edges of the extension channels 427A-427D maintains the shield lid 440 in position over the housing 400. That is, the mechanical interference prevents the shield lid 440 from rotating with respect to the housing 400, beyond a nominal clearance between the interlock arms 447A-447D and the extension channels 427A-427D. However, the shield lid 440 can still move in the direction “D” shown in FIG. 4A, as the curved ends of the interlock arms 447A-447D can shift or slide along the lengths of the extension channels 427A-427D. The lengths of the interlock arms 447A-447D and the extension channels 427A-427D can vary as compared to that shown, to determine or set the range of movement or travel between the shield lid 440 and the housing 400.

Referring to FIG. 4E, the housing 400 also includes interlock apertures 425A-425D. The interlock apertures 425A-425D are formed through the housing 400 and extend through the outer surface 403 to an inner surface 404 of the housing 400. The interlock apertures 425A-425D are formed to help position and interlock the insulating interposer 430 within the housing 400. The housing 400 also includes interlock cutouts 426A and 426B. The interlock cutouts 426A and 426B are formed as cutouts from the bottom edge of the housing 400. The interlock cutouts 426A and 426B are also formed to help position and interlock the insulating interposer 430 within the housing 400. The housing 400 also includes catch hooks 428A-428D. The catch hooks 428A-428D curl around and can contact the top end of the insulating interposer 430, helping to secure the insulating interposer 430 into position with the housing 400. In other examples, the number, sizes, shapes, and positions of the interlock apertures 425A-425D, the interlock cutouts 426A and 426B, and the catch hooks 428A-328D of the housing 400 can vary as compared to that shown.

Referring to FIG. 4F, the interposer 430 includes a bottom surface 431, an upper platform surface 432A, a lower platform surface 432B, and an outer surface 433, among other edges and surfaces. The outer surface 433 of the interposer 430 is cylindrical in the example shown. A central aperture 434 extends through the interposer 430, and the pin 470 extends through the central aperture 434. The central aperture 434 extends from a first opening in the upper platform surface 432A, through the interposer 430, and to a second opening in the bottom surface 431 of the interposer 430. The pin 470 is positioned, extends within, and occupies the central aperture 434. As shown in FIGS. 4C and 4D, opposite ends of the pin 470 are exposed both at a top of the interposer 430 and at bottom of the interposer 430.

The interposer 430 includes interlock extensions 435A and 435B, among others, which extend out and beyond from the outer surface 433 of the interposer 430. The interlock extensions 435A and 435B are seated and positioned into the interlock apertures 425A and 425B of the housing 400 when the interposer 430 is positioned within the housing 400, as shown in FIG. 4G. A mechanical interference between the edges of the interlock extensions 435A and 435B and the interlock apertures 425A and 425B of the housing 400 maintains the position of the interposer 430 within the housing 400. The mechanical interference prevents the interposer 430 from moving or rotating with respect to the housing 400 when the interface contactor 40 is assembled. The interposer 430 also includes the interlock extensions 436A and 436B. The interlock extensions 436A and 436B are seated and positioned into the interlock cutouts 426A and 426B of the housing 400, when the interposer 430 is positioned within the housing 400. A mechanical interference between the edges of the interlock extensions 436A and 436B and the interlock cutouts 426A and 426B of the housing 400 maintains the position of the interposer 430.

The pin 470 of the interface contactor 40 is formed from conductive materials, such as copper, brass, nickel, or other metals and is conductive. The pin 470 can be similar to or the same as the pin 170 described above in FIG. 1F. The pin 470 can include a bottom plunger pin, a top plunger pin, a lower barrel rim, an upper barrel rim, and a pin barrel. The pin 470 can be spring-loaded and, although not visible, include a spring or other biasing member that extends within the pin barrel and between the top and bottom pin plungers. The spring applies a force to the top and bottom plunger pins. However, based on an external force, the top plunger pin can be pushed down into the pin barrel of the pin 470, overcoming the spring bias. In some cases, based on an external force, the bottom plunger pin can be pushed up into the pin barrel of the pin 470, overcoming the spring bias. In one example, the pin 470 can be embodied as a pogo-style pin, but other types and styles of pins can be relied upon.

Turning to FIG. 4G, the spring 420 is illustrated above the housing 400 and the interposer 430. The spring 420 includes a number of wave washers 422A-422D that are stacked upon and secured to each other. When the interface contactor 40 is assembled, the lower end or side of the spring 420 is positioned over and rests upon the lower platform surface 432B of the interposer 430 within the housing 400. The upper end of the spring 420 pushes up against the bottom surface of the upper rim 441A of the shield lid 440. The spring 420 maintains the interface contactor 40 in the extended configuration shown in FIG. 4A without an external force applied to the interface contactor 40. An external force applied down against the top of the shield lid 440 in the direction “D” can overcome the spring bias of the spring 420, to compress the interface contactor 40, as shown in FIG. 4H.

The interface contactor 40 provides a first conductive ground, common, or drain pathway between the upper rim 441A of the shield lid 440 and the bottom surfaces of the legs 410-413 of the housing 400. The interface contactor 40 also provides a second conductive pathway, such as for RF signals, through the pin 470. The pin 470 is electrically isolated from the shield lid 440 and the housing 400 by the interposer 430, which is insulating. Thus, the interface contactor 40 provides two separate conductive pathways for electrical interface purposes.

The overall height of the interface contactor 40 (i.e., as measured from the top to the bottom of the page in FIG. 4A) can range in various embodiments, such as between 2.5 mm to 7.5 mm, although the interface contactor 40 can be designed to other sizes. It should be appreciated, in any case, that the interface contactor 40 is capable of providing an electrical interface over a range of spacings or dimensions between two PCBs. In that context, the interface contactor 40 can be positioned between two PCBs, similar to the PCBs 190 and 192 shown in FIG. 1H. The interface contactor 40 can be compressed to some extent in the direction “D” shown in FIG. 4A when electrically coupled between PCBs. The interface contactor 40 is also capable of accommodating a tilt angle φ between PCBs.

FIG. 4H illustrates an example of the interface contactor 40 shown in FIG. 4A in a compressed state according to various embodiments of the present disclosure. FIG. 4H is a representative example, and the interface contactor 30 can be compressed to a lesser extent in some cases. The interface contactor 40 can be compressed between PCBs, such as the PCBs 190 and 192 shown in FIG. 1H, for example, to facilitate a range of spacings between PCBs. FIG. 4H also illustrates the top plunger pin of the pin 470 being pressed down due to compression of the pin 370.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included.

The terms “about” and “substantially,” unless otherwise defined herein to be associated with a particular range, percentage, or related metric of deviation, account for at least some manufacturing tolerances between a theoretical design and a manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

1. A board-to-board interface contactor, comprising:
a contactor base body, the contactor body base comprising a peripheral seat and an aperture;
an elastic and conductive lid positioned over the peripheral seat of the contactor base body; and
a conductive pin extending through the aperture in the contactor base body.

2. The board-to-board interface contactor according to claim 1, wherein:
the contactor base body further comprises a mounting leg; and
outer surfaces of the peripheral seat and the mounting leg are plated and conductive.

3. The board-to-board interface contactor according to claim 2, wherein:
the elastic and conductive lid comprises a conductive foam material; and
the interface contactor comprises a conductive pathway between the elastic and conductive lid, the peripheral seat, and the mounting leg.

4. The board-to-board interface contactor according to claim 3, wherein:
the interface contactor comprises a second conductive pathway through the conductive pin; and
the conductive pathway between the elastic and conductive lid, the peripheral seat, and the mounting leg is electrically insulated from the second conductive pathway through the conductive pin.

5. The board-to-board interface contactor according to claim 1, wherein:
the contactor base body further comprises a body pedestal having an outer cylindrical surface; and
the aperture extends through the body pedestal.

6. The board-to-board interface contactor according to claim 5, wherein:
the elastic and conductive lid comprises a bottom surface, a central opening, and an inner cylindrical surface within the central opening;
the bottom surface of the elastic and conductive lid contacts an upper seat surface of the peripheral seat; and
the inner cylindrical surface of the elastic and conductive lid contacts the outer cylindrical surface of the body pedestal.

7. The board-to-board interface contactor according to claim 1, wherein the conductive pin comprises a compressible plunger pin.

8. A board-to-board interface contactor, comprising:
a contactor base housing, the contactor base housing comprising a housing seat flange;
an elastic and conductive lid positioned over the housing seat flange of the contactor base housing;
an insulating interposer positioned within the contactor base housing; and
a conductive pin extending through an aperture in the insulating interposer.

9. The board-to-board interface contactor according to claim 8, wherein:
the elastic and conductive lid comprises a conductive foam material; and
the interface contactor comprises a conductive pathway between the elastic and conductive lid and the contactor base housing.

10. The board-to-board interface contactor according to claim 9, wherein:
the interface contactor comprises a second conductive pathway through the conductive pin; and
the conductive pathway between the elastic and conductive lid and the contactor base housing is electrically insulated from the second conductive pathway through the conductive pin.

11. The board-to-board interface contactor according to claim 8, wherein:
the elastic and conductive lid comprises a bottom surface, a central opening, and an inner cylindrical surface within the central opening;
the bottom surface of the elastic and conductive lid contacts an upper surface of the housing seat flange of the contactor base housing; and
the inner cylindrical surface of the elastic and conductive lid contacts an outer cylindrical surface of the contactor base housing.

12. The board-to-board interface contactor according to claim 8, wherein:
the insulating interposer comprises an interlock extension that extends beyond an outer cylindrical surface of the insulating interposer;
the contactor base housing further comprises an interlock aperture; and
the interlock extension of the insulating interposer is positioned within the interlock aperture of the contactor base housing, to maintain a position of the insulating interposer within the contactor base housing.

13. The board-to-board interface contactor according to claim 8, wherein the conductive pin comprises a compressible plunger pin.

14. A board-to-board interface contactor, comprising:
a contactor base housing, the contactor base housing comprising a spring seat flange;
a spring positioned over the spring seat flange of the contactor base housing;
a contactor shield extending in part between the spring and the contactor base housing;
an insulating interposer positioned within the contactor base housing; and
a conductive pin extending through an aperture in the insulating interposer.

15. The board-to-board interface contactor according to claim 14, wherein the contactor shield comprises an upper rim, a lower barrel, and a central opening extending within the lower barrel.

16. The board-to-board interface contactor according to claim 15, wherein the spring provides a spring bias between the spring seat flange of the contactor base housing and the upper rim of the contactor shield.

17. The board-to-board interface contactor according to claim 14, wherein:
the insulating interposer comprises an interlock extension that extends beyond an outer cylindrical surface of the insulating interposer;
the contactor base housing further comprises an interlock aperture; and
the interlock extension of the insulating interposer is positioned within the interlock aperture of the contactor base housing, to maintain a position of the insulating interposer within the contactor base housing.

18. The board-to-board interface contactor according to claim 14, wherein the conductive pin comprises a compressible plunger pin.

19. A board-to-board interface contactor, comprising:
a shield body housing;
an insulating interposer positioned within the shield body housing;
a wave spring positioned over the insulating interposer;
a shield lid positioned over the shield body housing and the wave spring; and
a conductive pin extending through an aperture in the insulating interposer.

20. The board-to-board interface contactor according to claim 19, wherein:
the insulating interposer comprises an interlock extension that extends beyond an outer cylindrical surface of the insulating interposer;
the shield body housing further comprises an interlock aperture; and
the interlock extension of the insulating interposer is positioned within the interlock aperture of the shield body housing, to maintain a position of the insulating interposer within the shield body housing.

21. The board-to-board interface contactor according to claim 19, wherein:
the shield lid further comprises an interlock arm;
the shield body housing further comprises an extension channel; and
the interlock arm of the shield lid is positioned within the extension channel of the shield body housing.
